(19) United States
(12) Patent Application Publication
(10) Pub. No.: US 2024/0406941 A1
(43) Pub. Date: Dec. 5, 2024

(54) LOW PEAK-TO-AVERAGE POWER RATIO WAVEFORM OVER FRAGMENTED FREQUENCY RESOURCES

(71) Applicant: QUALCOMM Incorporated, San Diego, CA (US)

(72) Inventors: Vinayak SURESH, San Diego, CA (US); Kianoush HOSSEINI, San Diego, CA (US); Jing JIANG, San Diego, CA (US)

(21) Appl. No.: 18/327,782

(22) Filed: Jun. 1, 2023

(51) Int. Cl. H04W 72/0453

(52) U.S. Cl. CPC H04W 72/0453

(57) ABSTRACT

Certain aspects of the present disclosure provide a method of wireless communication at a transmitting device, generally including selecting, based on one or more criteria, a scheme for generating a waveform that accounts for unavailable frequency resources within an allocation of resource elements (REs), obtaining a sequence of frequency domain symbols, generating the waveform by mapping at least some of the sequence of frequency domain symbols to REs within the allocation according to the selected scheme, and outputting the waveform for transmission.

### BACKGROUND

### Field of the Disclosure

Aspects of the present disclosure relate to wireless communications, and more particularly, to techniques for managing peak-to-average power ratio in waveform transmitted using fragmented frequency resources.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method of wireless communication at a transmitting device. The method includes selecting, based on one or more criteria, a scheme for generating a waveform that accounts for unavailable frequency resources within an allocation of resource elements (REs); obtaining a sequence of frequency domain symbols; generating the waveform by mapping at least some of the sequence of frequency domain symbols to REs within the allocation according to the selected scheme; and outputting the waveform for transmission.

Another aspect provides a method of wireless communication at a receiving device. The method includes obtaining a waveform; selecting, based on one or more criteria, a scheme for processing the waveform that accounts for unavailable frequency resources within an allocation of REs; and extracting a sequence of frequency domain symbols from the waveform based on the selected scheme.

Other aspects provide: an apparatus operable, configured, or otherwise adapted to perform any one or more of the aforementioned methods and/or those described elsewhere herein; a non-transitory, computer-readable media comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of an example base station and an example user equipment.

FIGS. 4A, 4B, 4C, and 4D depict various example aspects of data structures for a wireless communications network.

FIG. 5 depicts examples of fragmented frequency resources.

FIG. 6 depicts an example of single carrier waveform generation.

FIG. 7 depicts an example of single carrier waveform generation over fragmented frequency resources.

FIG. 8 is an example call flow diagram, according to aspects of the present disclosure.

FIG. 9 depicts an example of single carrier waveform generation over fragmented frequency resources using a first scheme to manage peak-to-average power ratio, according to aspects of the present disclosure.

FIG. 10 depicts an example of single carrier waveform generation over fragmented frequency resources using a second scheme to manage peak-to-average power ratio, according to aspects of the present disclosure.

FIG. 11 depicts an example of single carrier waveform generation over fragmented frequency resources using a third scheme to manage peak-to-average power ratio, according to aspects of the present disclosure.

FIG. 12 depicts a first example of how parameters may be used to select a scheme for managing peak-to-average power ratio, according to aspects of the present disclosure.

FIG. 13 depicts a second example of how parameters may be used to select a scheme for managing peak-to-average power ratio, according to aspects of the present disclosure.

FIG. 14 depicts a third example of how parameters may be used to select a scheme for managing peak-to-average power ratio, according to aspects of the present disclosure.

FIGS. 15A and 15B compare the performance different schemes for managing peak-to-average power ratio for different scenarios, according to aspects of the present disclosure.

FIGS. 16-18 depict examples of fragmented frequency resources.

FIGS. 19-25 depict examples of single carrier waveform generation when unavailable resources are comb based.

FIG. 26 depicts a method for wireless communications.

FIG. 27 depicts a method for wireless communications.

FIG. 28 depicts aspects of an example communications device.

### DETAILED DESCRIPTION

Aspects of the present disclosure provide apparatuses, methods, processing systems, and computer-readable mediums for managing peak-to-average power ratio (PAPR) in waveform transmitted using fragmented frequency resources.

A waveform generally defines the physical shape of a signal that carries modulated information through a wireless channel. At the transmitter, the information in the form of symbols is mapped from data space to the signal space and a reverse operation is performed at the receiver to recover the message. A symbol generally refers to a set of complex numbers generated by grouping a number of bits together. The number of bits grouped within one symbol determines what is referred to as a modulation order.

In current wireless systems (e.g., 5G NR), for various reasons, a waveform may be transmitted over fragmented frequency resources. In this context, fragmented means some portion of a continuous allocation of frequency resources is unavailable. In certain types of waveforms, modulated symbols are generated in the time-domain, such that the unavailability of even one resource element (RE) may degrade the error vector magnitude (EVM) for a large number of modulated symbols. This may be the case for single-carrier waveforms, such as direct Fourier transform spread OFDM (DFT-s-OFDM), zero tail DFT-s-OFDM, single-carrier quadrature amplitude modulation (SC-QAM), and the like. Single carrier waveforms are desirable, as they can often result in lower power average to peak ratio (PAPR) than other types of waveforms. However, fragmented resources may increase PAPR.

Aspects of the present disclosure, however, provide mechanisms for selecting a scheme for PAPR reduction when transmitting a single carrier waveform over fragmented frequency resources. For example, the mechanism may select a particular scheme based on various factors, such as modulation order or modulation and coding scheme (MCS). In some cases, the selection may be based on characteristics of the fragmented frequency resources, such as an allocation size, gap sizes, number of gaps, and gap locations within the allocation. Selecting an appropriate scheme may help optimize PAPR reduction, which may enhance wireless signaling by increasing achievable throughput.

### Introduction to Wireless Communications Networks

The techniques and methods described herein may be used for various wireless communications networks. While aspects may be described herein using terminology commonly associated with 3G, 4G, and/or 5G wireless technologies, aspects of the present disclosure may likewise be applicable to other communications systems and standards not explicitly mentioned herein.

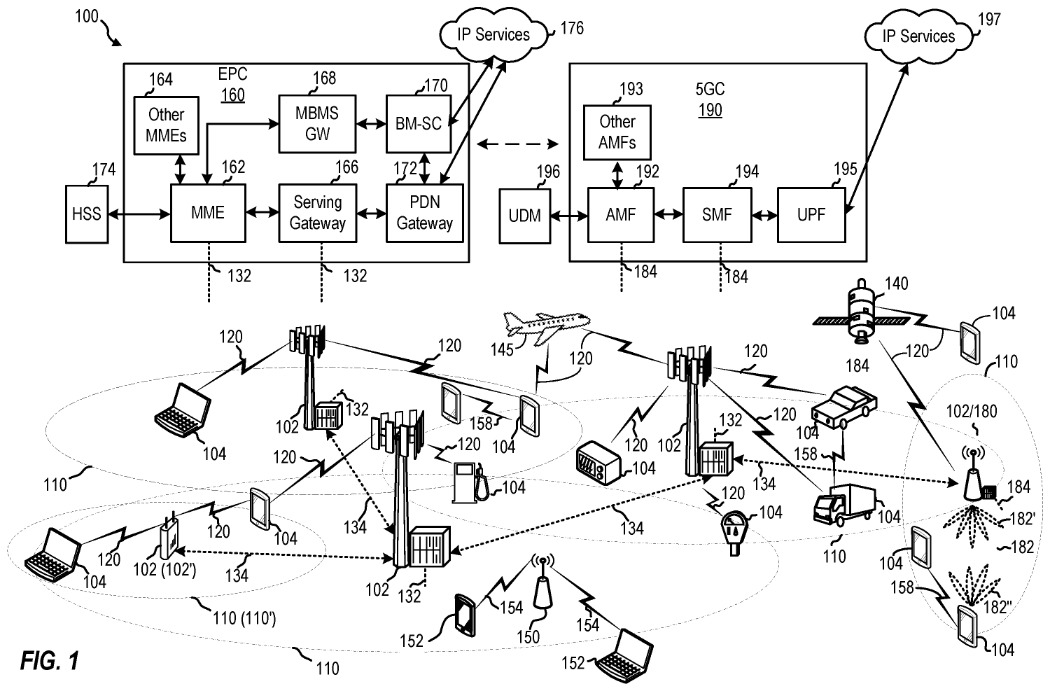

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). For example, various functions of a network as well as various devices associated with and interacting with a network may be considered network entities. Further, wireless communications network 100 includes terrestrial aspects, such as ground-based network entities (e.g., BSs 102), and non-terrestrial aspects, such as satellite 140 and aircraft 145, which may include network entities on-board (e.g., one or more BSs) capable of communicating with other network elements (e.g., terrestrial BSs) and user equipments.

In the depicted example, wireless communications network 100 includes BSs 102, UEs 104, and one or more core networks, such as an Evolved Packet Core (EPC) 160 and 5G Core (5GC) network 190, which interoperate to provide communications services over various communications links, including wired and wireless links.

FIG. 1 depicts various example UEs 104, which may more generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. UEs 104 may also be referred to more generally as a mobile device, a wireless device, a wireless communications device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. The communications links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communications links 120 may use multiple-input and multiple-output (MIMO) antenna technology, including spatial multiplexing, beamforming, and/or transmit diversity in various aspects.

BSs 102 may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. Each of BSs 102 may provide communications coverage for a respective geographic coverage area 110, which may sometimes be referred to as a cell, and which may overlap in some cases (e.g., small cell 102′ may have a coverage area 110′ that overlaps the coverage area 110 of a macro cell). A BS may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

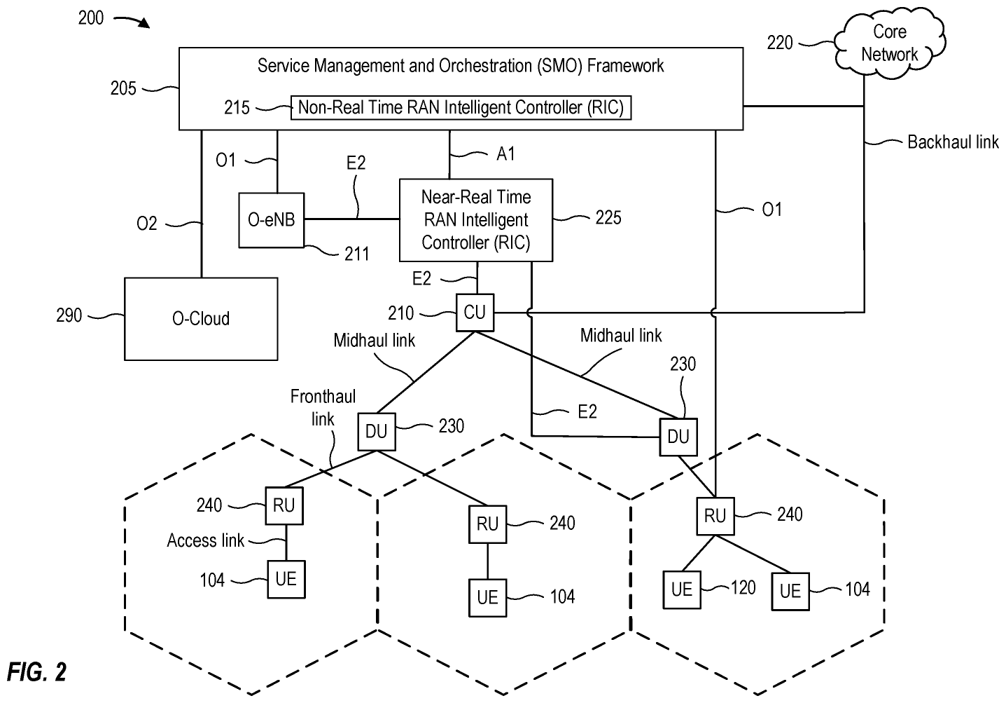

While BSs 102 are depicted in various aspects as unitary communications devices, BSs 102 may be implemented in various configurations. For example, one or more components of a base station may be disaggregated, including a central unit (CU), one or more distributed units (DUs), one or more radio units (RUS), a Near-Real Time (Near-RT) RAN Intelligent Controller (RIC), or a Non-Real Time (Non-RT) RIC, to name a few examples. In another example, various aspects of a base station may be virtualized. More generally, a base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 2 depicts and describes an example disaggregated base station architecture.

Different BSs 102 within wireless communications network 100 may also be configured to support different radio access technologies, such as 3G, 4G, and/or 5G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, 3GPP currently defines Frequency Range 1 (FR1) as including 410 MHz-7125 MHz, which is often referred to (interchangeably) as “Sub-6 GHz”. Similarly, 3GPP currently defines Frequency Range 2 (FR2) as including 24,250 MHz-52,600 MHZ, which is sometimes referred to (interchangeably) as a “millimeter wave” (“mmW” or “mmWave”). A base station configured to communicate using mmWave/near mmWave radio frequency bands (e.g., a mmWave base station such as BS 180) may utilize beamforming (e.g., 182) with a UE (e.g., 104) to improve path loss and range.

The communications links 120 between BSs 102 and, for example, UEs 104, may be through one or more carriers, which may have different bandwidths (e.g., 5, 10, 15, 20, 100, 400, and/or other MHz), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may then perform beam training to determine the best receive and transmit directions for each of BS 180 and UE 104. Notably, the transmit and receive directions for BS 180 may or may not be the same. Similarly, the transmit and receive directions for UE 104 may or may not be the same.

Wireless communications network 100 further includes a Wi-Fi AP 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172, such as in the depicted example. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and 5GC 190. AMF 192 provides, for example, quality of service (QOS) flow and session management.

Internet protocol (IP) packets are transferred through UPF 195, which is connected to the IP Services 197, and which provides UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a sidelink node, to name a few examples.

FIG. 2 depicts an example disaggregated base station 200 architecture. The disaggregated base station 200 architecture may include one or more central units (CUs) 210 that can communicate directly with a core network 220 via a backhaul link, or indirectly with the core network 220 through one or more disaggregated base station units (such as a Near-Real Time (Near-RT) RAN Intelligent Controller (RIC) 225 via an E2 link, or a Non-Real Time (Non-RT) RIC 215 associated with a Service Management and Orchestration (SMO) Framework 205, or both). A CU 210 may communicate with one or more distributed units (DUs) 230 via respective midhaul links, such as an F1 interface. The DUs 230 may communicate with one or more radio units (RUS) 240 via respective fronthaul links. The RUs 240 may communicate with respective UEs 104 via one or more radio frequency (RF) access links. In some implementations, the UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

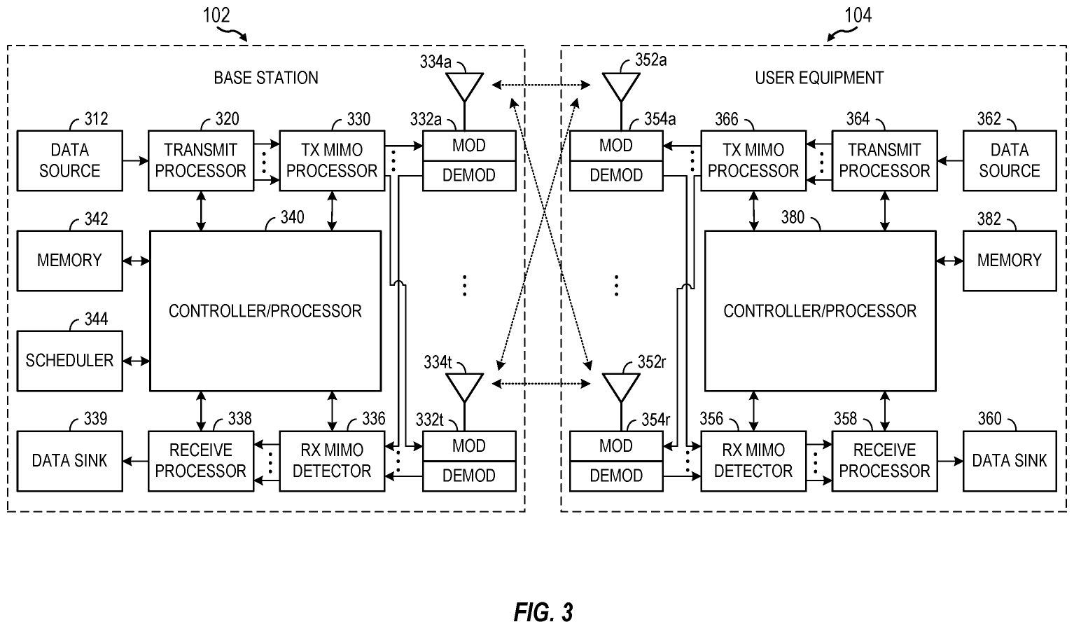

FIG. 3 depicts aspects of an example BS 102 and a UE 104.

Generally, BS 102 includes various processors (e.g., 320, 330, 338, and 340), antennas 334a-t (collectively 334), transceivers 332a-t (collectively 332), which include modulators and demodulators, and other aspects, which enable wireless transmission of data (e.g., data source 312) and wireless reception of data (e.g., data sink 339). For example, BS 102 may send and receive data between BS 102 and UE 104. BS 102 includes controller/processor 340, which may be configured to implement various functions described herein related to wireless communications.

Generally, UE 104 includes various processors (e.g., 358, 364, 366, and 380), antennas 352a-r (collectively 352), transceivers 354a-r (collectively 354), which include modulators and demodulators, and other aspects, which enable wireless transmission of data (e.g., retrieved from data source 362) and wireless reception of data (e.g., provided to data sink 360). UE 104 includes controller/processor 380, which may be configured to implement various functions described herein related to wireless communications.

In regards to an example downlink transmission, BS 102 includes a transmit processor 320 that may receive data from a data source 312 and control information from a controller/processor 340. The control information may be for the physical broadcast channel (PBCH), physical control format indicator channel (PCFICH), physical HARQ indicator channel (PHICH), physical downlink control channel (PDCCH), group common PDCCH (GC PDCCH), and/or others. The data may be for the physical downlink shared channel (PDSCH), in some examples.

Transmit processor 320 may process (e.g., encode and symbol map) the data and control information to obtain data symbols and control symbols, respectively. Transmit processor 320 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 330 may perform spatial processing (e.g., precoding) on the data symbols, the control symbols, and/or the reference symbols, if applicable, and may provide output symbol streams to the modulators (MODs) in transceivers 332a-332t. Each modulator in transceivers 332a-332t may process a respective output symbol stream to obtain an output sample stream. Each modulator may further process (e.g., convert to analog, amplify, filter, and upconvert) the output sample stream to obtain a downlink signal. Downlink signals from the modulators in transceivers 332a-332t may be transmitted via the antennas 334a-334t, respectively.

In order to receive the downlink transmission, UE 104 includes antennas 352a-352r that may receive the downlink signals from the BS 102 and may provide received signals to the demodulators (DEMODs) in transceivers 354a-354r, respectively. Each demodulator in transceivers 354a-354r may condition (e.g., filter, amplify, downconvert, and digitize) a respective received signal to obtain input samples. Each demodulator may further process the input samples to obtain received symbols.

MIMO detector 356 may obtain received symbols from all the demodulators in transceivers 354a-354r, perform MIMO detection on the received symbols if applicable, and provide detected symbols. Receive processor 358 may process (e.g., demodulate, deinterleave, and decode) the detected symbols, provide decoded data for the UE 104 to a data sink 360, and provide decoded control information to a controller/processor 380.

In regards to an example uplink transmission, UE 104 further includes a transmit processor 364 that may receive and process data (e.g., for the PUSCH) from a data source 362 and control information (e.g., for the physical uplink control channel (PUCCH)) from the controller/processor 380. Transmit processor 364 may also generate reference symbols for a reference signal (e.g., for the sounding reference signal (SRS)). The symbols from the transmit processor 364 may be precoded by a TX MIMO processor 366 if applicable, further processed by the modulators in transceivers 354a-354r (e.g., for SC-FDM), and transmitted to BS 102.

At BS 102, the uplink signals from UE 104 may be received by antennas 334a-t, processed by the demodulators in transceivers 332a-332t, detected by a MIMO detector 336 if applicable, and further processed by a receive processor 338 to obtain decoded data and control information sent by UE 104. Receive processor 338 may provide the decoded data to a data sink 339 and the decoded control information to the controller/processor 340.

Memories 342 and 382 may store data and program codes for BS 102 and UE 104, respectively.

Scheduler 344 may schedule UEs for data transmission on the downlink and/or uplink.

In various aspects, BS 102 may be described as transmitting and receiving various types of data associated with the methods described herein. In these contexts, “transmitting” may refer to various mechanisms of outputting data, such as outputting data from data source 312, scheduler 344, memory 342, transmit processor 320, controller/processor 340, TX MIMO processor 330, transceivers 332a-t, antenna 334a-t, and/or other aspects described herein. Similarly, “receiving” may refer to various mechanisms of obtaining data, such as obtaining data from antennas 334a-t, transceivers 332a-t, RX MIMO detector 336, controller/processor 340, receive processor 338, scheduler 344, memory 342, and/or other aspects described herein.

In various aspects, UE 104 may likewise be described as transmitting and receiving various types of data associated with the methods described herein. In these contexts, “transmitting” may refer to various mechanisms of outputting data, such as outputting data from data source 362, memory 382, transmit processor 364, controller/processor 380, TX MIMO processor 366, transceivers 354a-t, antenna 352a-t, and/or other aspects described herein. Similarly, “receiving” may refer to various mechanisms of obtaining data, such as obtaining data from antennas 352a-t, transceivers 354a-t, RX MIMO detector 356, controller/processor 380, receive processor 358, memory 382, and/or other aspects described herein.

In some aspects, a processor may be configured to perform various operations, such as those associated with the methods described herein, and transmit (output) to or receive (obtain) data from another interface that is configured to transmit or receive, respectively, the data.

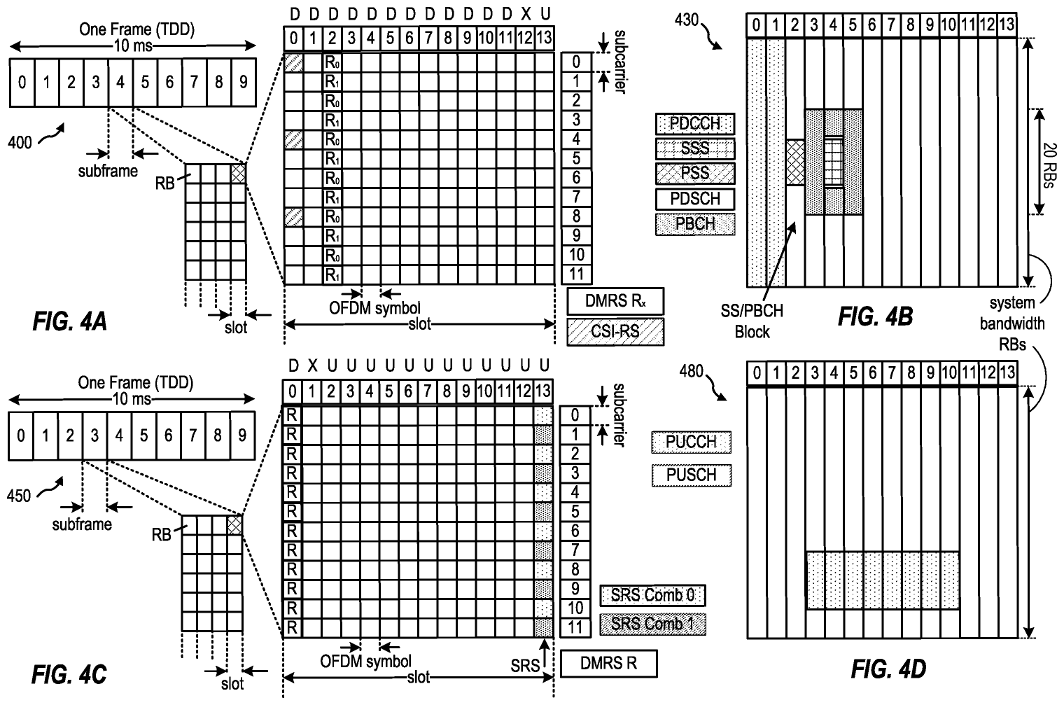

FIGS. 4A, 4B, 4C, and 4D depict aspects of data structures for a wireless communications network, such as wireless communications network 100 of FIG. 1.

In particular, FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and single-carrier frequency division multiplexing (SC-FDM) partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL. U is UL, and X is flexible for use between DL/UL. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 7 or 14 symbols, depending on the slot format. Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology u, there are 14 symbols/slot and 2μ slots/subframe. The subcarrier spacing and symbol length/duration are a function of the numerology. The subcarrier spacing may be equal to 24×15 kHz, where u is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RS) for a UE (e.g., UE 104 of FIGS. 1 and 3). The RS may include demodulation RS (DMRS) and/or channel state information reference signals (CSI-RS) for channel estimation at the UE. The RS may also include beam measurement RS (BRS), beam refinement RS (BRRS), and/or phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as R for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Aspects Related to Managing PAPR for a Waveform Transmitted Over Fragmented Frequency Resources

Aspects of the present disclosure provide apparatuses, methods, processing systems, and computer-readable mediums for managing peak-to-average power ratio (PAPR) in waveform transmitted using fragmented frequency resources.

Certain waveforms may be used for certain purposes, based on desired characteristics. For example, Discrete Fourier Transform Spread Orthogonal Frequency Division Multiplexing (DFT-s-OFDM) waveforms may be used in uplink transmissions. DFT-s-OFDM has a single carrier (SC) property, resulting in a lower Peak-to-Average Power Ratio (PAPR). Lower PAPR makes for better power efficiency, enhancing efficiency and coverage, since operations may be performed closer to power amplifier (PA) saturation while meeting requirements (e.g., emission requirements).

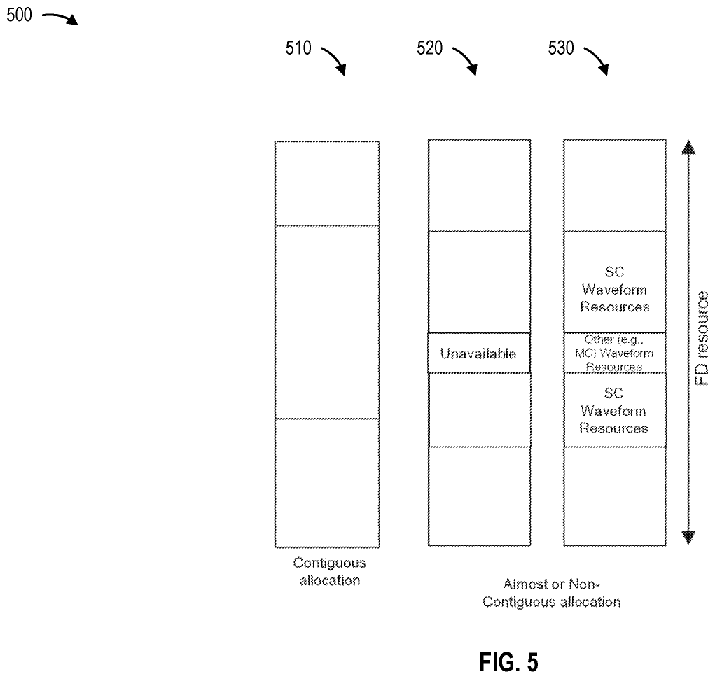

As noted above, in current wireless systems (e.g., 5G NR), for various reasons, a waveform may be transmitted over fragmented frequency resources. For example, as illustrated in FIG. 5, a contiguous allocation of frequency domain (FD) resources 510 may be fragmented, due to a certain portion of the FD resources being unavailable, as shown at 520.

For example, reserved frequency resources in uplink (UL) or downlink (DL) may cause some frequency resources to be unavailable to be used for data transmission. For example, resource blocks (RBs) may be reserved for uplink transmissions, such as physical uplink control channel (PUCCH) transmissions (e.g., 1 RB) or physical random access channel (PRACH) transmissions (e.g., 6 or 12 RBs), or comb-based transmissions (e.g., pilot or reference symbols like channel state information (CSI) reference signals (RS) in DL or sounding RSs (SRS) in uplink).

When a user equipment (UE) has data to transmit requiring a large number of RBs, unavailable/reserved frequency resources (e.g., reserved for PUCCH, PRACH, comb-based transmissions, or other UEs transmissions) may cause the available frequency resources for data in the same symbol to be fragmented. For scheduling flexibility, it may be desirable to schedule transmissions over such non-contiguous or fragmented groups of frequency resources (e.g., frequency resources having gaps of unavailable resources).

In some cases, as shown at 530, the unavailability of frequency resources for one type of waveform may be due to the multiplexing of another type of waveform in the same FD resources. For example, it may be desirable (e.g., for scheduling flexibility) to multiplex single carrier waveforms with comb-based transmissions (e.g., comb-based transmissions that are scheduled on resources that form gaps in a resource allocation). For example, in some cases, data of one user (e.g., with a DFT-s-OFDM waveform) may be multiplexed with SRS resources that may be assigned to another UE. Such multiplexing may be useful, for example, in scenarios where a single device may transmit multiple comb-based waveforms, but the final multiplexed waveform does not have a comb structure. However, such multiplexing may fail to maintain a low PAPR property.

Single carrier (SC) waveforms may be used in both DL (e.g., high band) and UL communications, and may provide benefits such as low PAPR and less sensitivity to phase noise. In some cases (e.g., in a scenario involving comb-based transmissions as described above), a single device may want to multiplex an SC waveform with another waveform(s) for different purposes, where the allocation for the SC waveform is not contiguous. Similar situations may arise for UL carrier aggregation (CA), multi-carrier sounding reference signals (SRS), or simultaneous physical uplink shared channel (PUSCH)/PUCCH transmissions.

Aspects of the present disclosure provide mechanisms that may help select an appropriate scheme to help reduce PAPR, when generating a waveform to be transmitted over fragmented FD resources. For example, the mechanism may choose between certain schemes (e.g., Null and shift, Null and append, Nulling or Puncturing only) to allow for scheduling transmissions over non-contiguous or fragmented groups of frequency resources, or to allow multiplexing of SC waveforms with comb-based transmissions, while maintaining a low PAPR property of a resulting waveform.

Selection of an appropriate scheme for PAPR reduction may depend on various factors such as modulation order, modulation and coding scheme (MCS), waveform type, allocation size (e.g., a number of resources available for single-carrier waveform or a number of resources allocated to comb-based transmissions), gap sizes, a number of gaps (e.g., comb sparsity), gap locations (e.g., comb structure) within the allocation, UE capabilities, complexity considerations, and requirements (e.g., error vector magnitude (EVM) or emissions requirements).

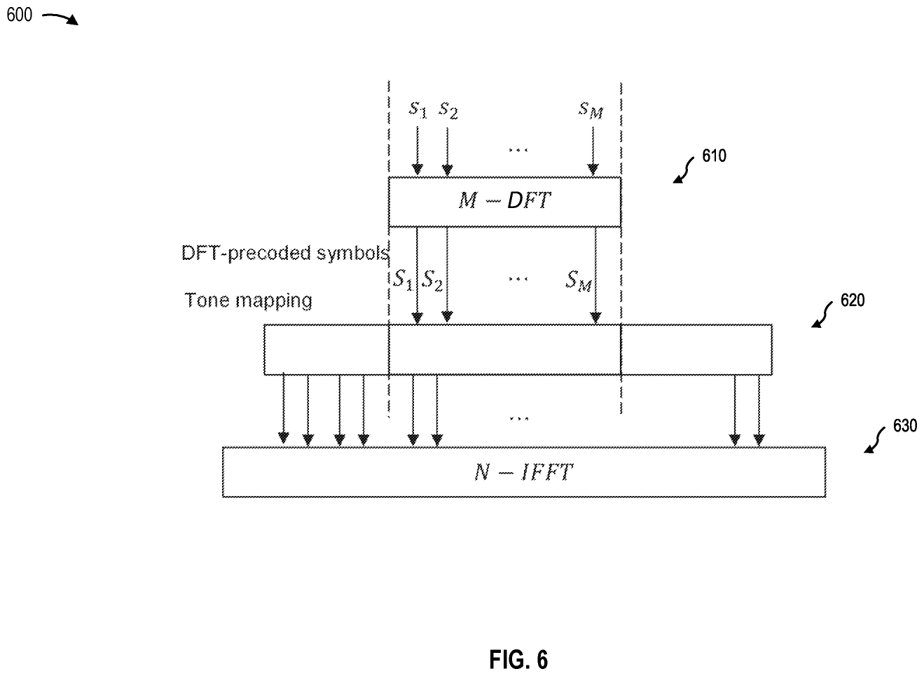

The various schemes proposed herein may be understood by comparison to a conventional scenario 600, shown in FIG. 6, for generating a DFT-s-OFDM waveform assuming a contiguous allocation in frequency. As illustrated at 610, an M-point DFT may be performed on M data (e.g., quadrature amplitude modulation (QAM)) symbols s₁, s₂, . . . , s_{M} to generate M DFT-precoded symbols s₁, s₂, . . . , s_{M}. In this example, M is the number of allocated REs, which is equivalent to the number of RBs allocated×12 (assuming 12 REs per RB). The M DFT-precoded symbols may then be mapped to tones (REs), at 620, before an N point IFFT is performed, at 630.

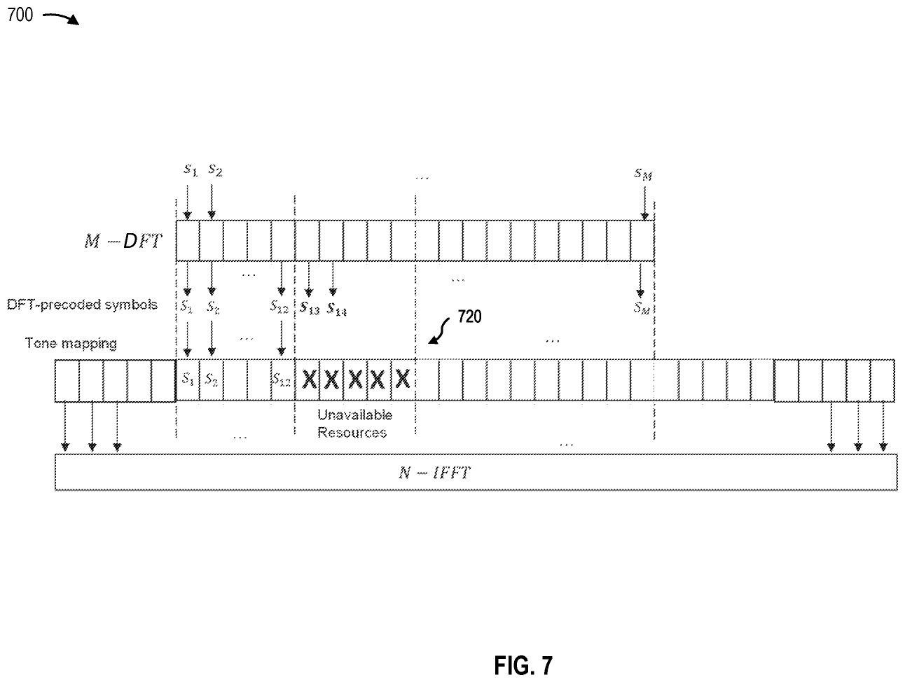

FIG. 7 illustrates an example scenario 700 where certain FD resources are unavailable, as shown at 720. Aspects of the present disclosure provide techniques for selection a scheme, from various schemes, for addressing such resource fragmentation with the goal of reducing PAPR.

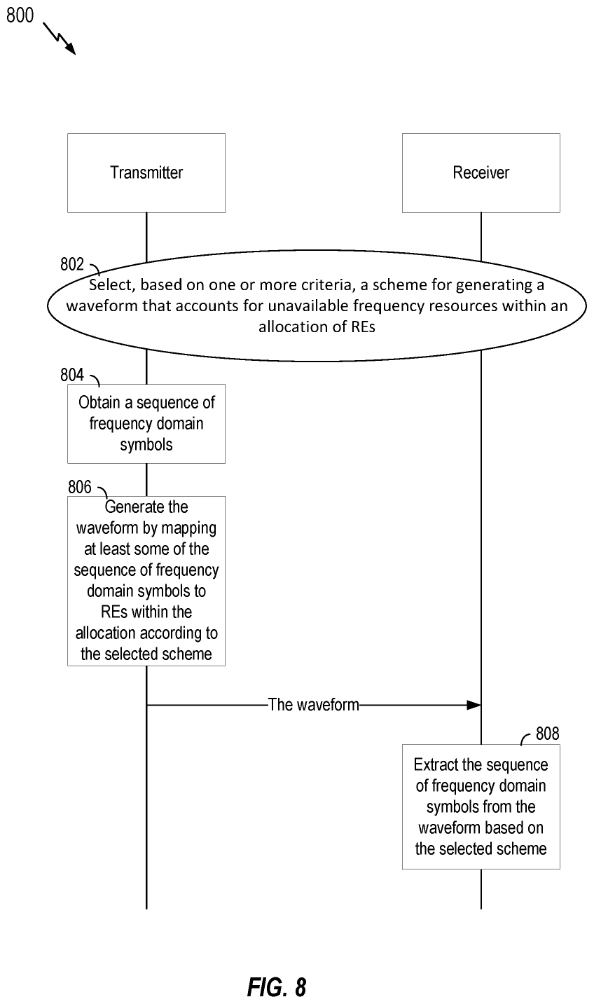

Techniques proposed herein may be understood with reference to the call flow diagram 800 shown in FIG. 8. The example depicts an example transmitter and receiver. In some aspects, the receiver may be an example of a network entity, such as the BS 102 depicted and described with respect to FIGS. 1 and 3, or a disaggregated base station depicted and described with respect to FIG. 2. Similarly, the transmitter may be an example of UE 104 depicted and described with respect to FIGS. 1 and 3. However, in other aspects, the transmitter and/or receiver may be another type of wireless communications device.

As illustrated at 802, the transmitter and receiver may first select, based on one or more criteria, a scheme for generating a waveform that accounts for unavailable frequency resources within an allocation of REs. In other words, both (Tx and Rx) sides may need to identify which tone(s) are unavailable and what scheme is used, so they may process accordingly. In other words, a transmitter may perform the techniques described herein to account for unavailable frequency resources, while the receiver needs to know what processing was performed at the transmitter, so it can perform corresponding (complementary) processing of the received waveform.

As will be described in greater detail below, selection of an appropriate scheme for PAPR reduction may depend on various factors such as modulation order, modulation and coding scheme (MCS), waveform type, allocation size (e.g., a number of resources available for single-carrier waveform or a number of resources allocated to comb-based transmissions), gap sizes, a number of gaps (e.g., comb sparsity), gap locations (e.g., comb structure) within the allocation, UE capabilities, complexity considerations, and requirements (e.g., error vector magnitude (EVM) or emissions requirements).

As illustrated at 804, the transmitter may obtain a sequence of frequency domain symbols. At 806, the transmitter may generate the waveform by mapping at least some of the sequence of frequency domain symbols to REs within the allocation according to the selected scheme. As illustrated at 808, the receiver may extract the sequence of frequency domain symbols from the waveform, based on the selected scheme.

As noted above with reference to FIG. 6, an M-point DFT may be performed on M data (e.g., QAM) symbols s₁, s₂, . . . , s_{M} to generate M DFT-precoded symbols s₁, s₂, . . . , s_{M} (e.g., S=Fs).

As noted above with reference to FIG. 7, certain FD resources may be unavailable. Aspects of the present disclosure provide techniques for selection a scheme, from various schemes, for addressing such resource fragmentation with the goal of reducing PAPR.

One scheme that may be selected (e.g., for generation of low PAPR DFT-s-OFDM waveforms when allocated frequency resources are not contiguous or for multiplexing SC transmission with comb-based transmissions) may be referred to as a Null and Shift scheme. The null and shift refer to an adjustment (shift) of a symbol to tone mapping to avoid transmission (null) on unavailable FD resources.

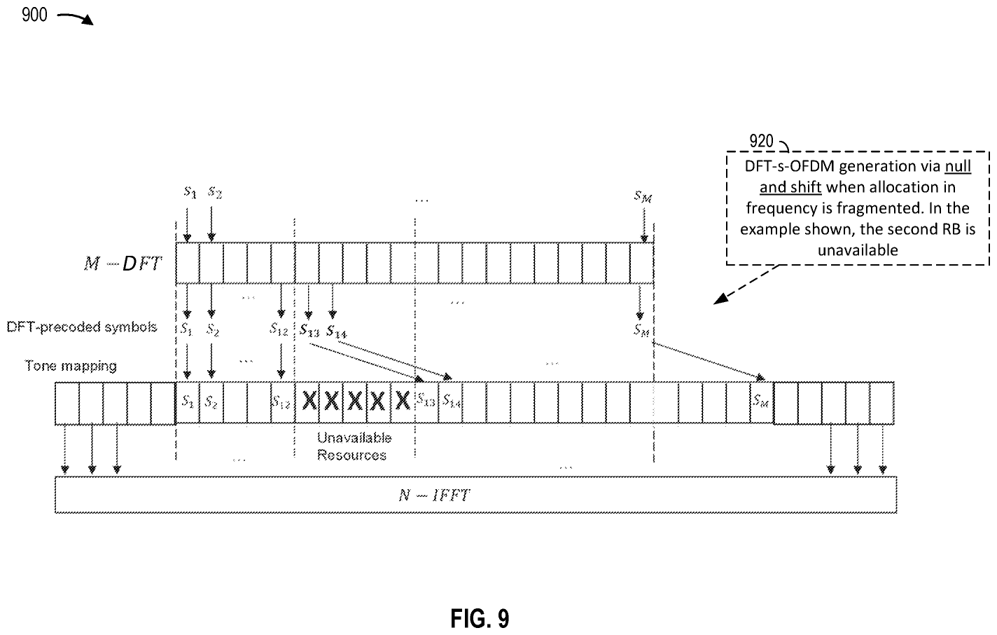

FIG. 9 illustrates DFT-s-OFDM generation via such a Null and Shift scheme. As noted at 920, when allocation in frequency is fragmented as in the example shown, where REs of the second RB are unavailable, the Null and Shift scheme may be used to avoid/account for the unavailable FD resources.

As illustrated, when using a Null and Shift scheme when there are one or more gaps (e.g., due to reserved resources including resources reserved for comb-based transmissions) in a frequency allocation, DFT-precoded data/tones may be mapped in a sequential or serial manner to available resources while skipping (e.g., not transmitting on) unavailable frequency resources (e.g., gaps). For example, as shown, symbols (S₁₃, S₁₄, . . . ) which would have otherwise been mapped to unavailable resources, are not transmitted on the unavailable resources (these REs are Nulled). The mapping of these symbols is instead shifted in a sequential manner to the next available resources (REs in the third RB). As illustrated, DFT-precoded symbols that follow (e.g., S₁₅ through S_{M}) may be mapped sequentially following the shifted mapping of S₁₃ and S₁₄.

In cases involving comb-based transmissions that extend outside of the allocation, comb-reserved REs may be skipped when shifting tones (e.g., using a Null and Shift scheme as described above). To skip different unavailable tones in the comb pattern, the nulling and shifting may be applied repeatedly, as needed.

Another scheme that may be selected (e.g., for generation of low PAPR DFT-s-OFDM waveforms when allocated frequency resources are fragmented) may be referred to as a Null and Append scheme. Rather than simply shifting the tone mapping, in the case of Null and Append, symbols mapped to unavailable frequency resources are mapped to tones appended to either side of the tone mapping.

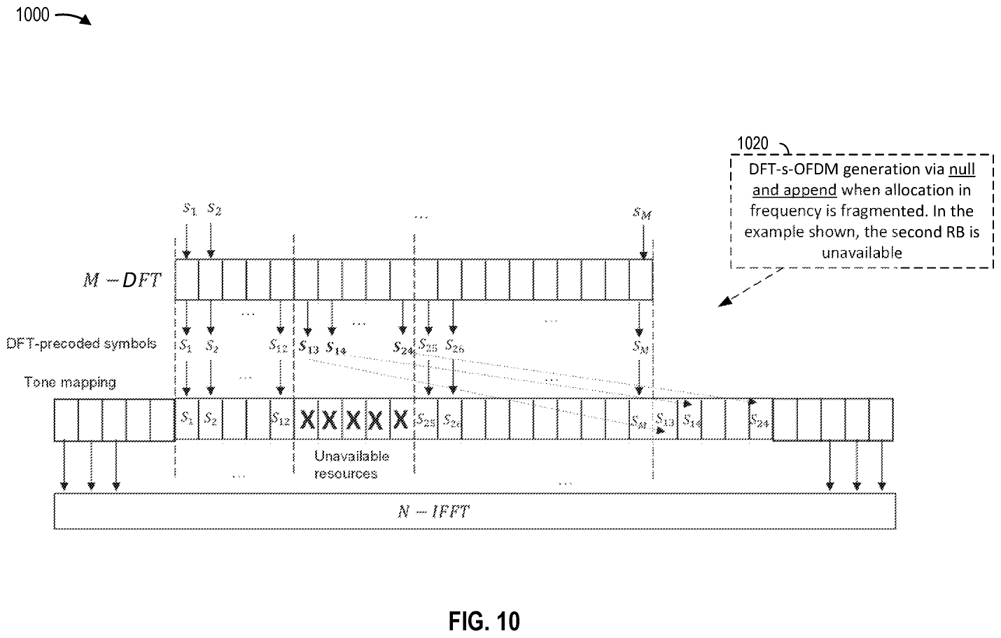

FIG. 10 illustrates DFT-s-OFDM generation via such a Null and Append scheme when allocation in frequency is fragmented. As illustrated at 1020, when using a Null and Append scheme when there are one or more gaps (e.g., due to reserved resources including resources reserved for comb-based transmissions) in a frequency allocation, DFT-precoded symbols mapped to unavailable resources may be appended to either (or both) ends of the allocation while skipping (e.g., not transmitting on) unavailable frequency resources (e.g., gaps). For example, as shown, S₁₃ through S₂₄, which would have otherwise been mapped to unavailable resources, are not transmitted on the unavailable resources, and are instead appended to the end of the allocation. In some cases, using a Null and Append scheme, the DFT-precoded symbols whose locations in frequency correspond to unavailable resources (e.g., S₁₃ through S₂₄ in the example illustrated in FIG. 10) may be appended to the beginning of the allocation or to both ends of the allocation.

In this manner, when using a Null and Append scheme, tones may be appended to either side of the allocation or may be appended to both sides (e.g., in order to reduce emission). For example, when using Null and Append scheme/mapping, tones may be appended on one side only or divided into two groups, each group being appended to a side of the allocation.

For example, for a 10 RB allocation, when 2 RBs in the middle are unavailable, the device may select to (or be configured to) append 1 RB on either side of the allocation. If the 10 RB allocation is close to the carrier edge, for example, this may help control an adjacent channel leakage ratio (ACLR).

As noted above, in cases involving comb-based transmissions that extend outside of the allocation, REs reserved for the comb-structure may be skipped when appending tones.

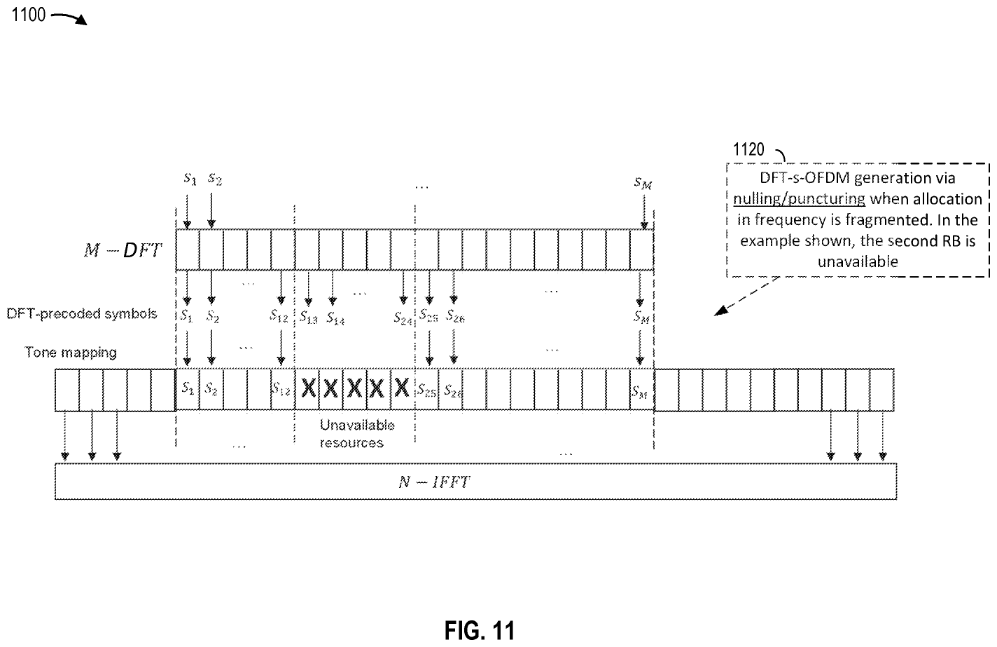

FIG. 11 illustrates DFT-s-OFDM generation via a Null only scheme when allocation in frequency is fragmented. This scheme may be considered a form of puncturing, as data bits corresponding to impacted symbols are not transmitted.

As illustrated at 1120, when using a Null only (Puncturing) scheme when there are one or more gaps (e.g., due to reserved resources including resources reserved for comb-based transmissions) in a frequency allocation, DFT-precoded symbols/tones whose locations in frequency correspond to unavailable resources are skipped (e.g., not transmitted on) unavailable frequency resources (e.g., gaps). While this scheme may lead to error vector magnitude (EVM) degradation, it may still be a viable scheme in certain scenarios. The viability of this scheme may depend on a multitude of factors such as MCS, number of unavailable resources, comb sparsity, and requirements (e.g., EVM or emissions requirements).

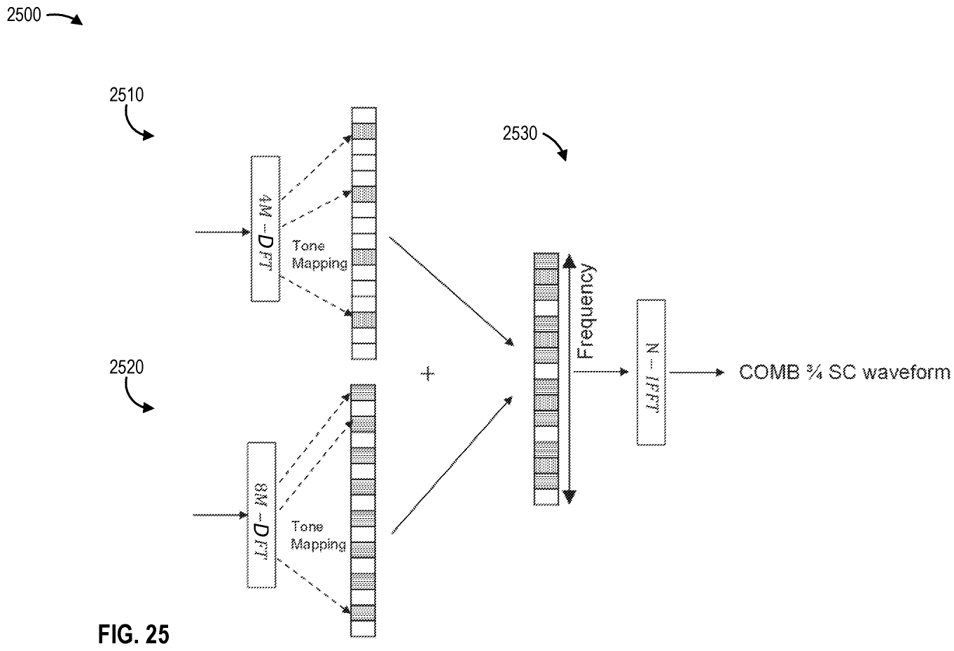

Similarly, for comb based transmissions, different possible schemes may be used (e.g., a Combining scheme, described in greater detail below with reference to FIG. 25), in addition to the schemes described above, and may be suitable for various scenarios.

As noted above, selection of an appropriate scheme for PAPR reduction may depend on various factors such as allocation size (e.g., a number of resources available for single-carrier waveform or a number of resources allocated to comb-based transmissions), gap sizes, a number of gaps (e.g., comb sparsity), or gap locations (e.g., comb structure) within the allocation.

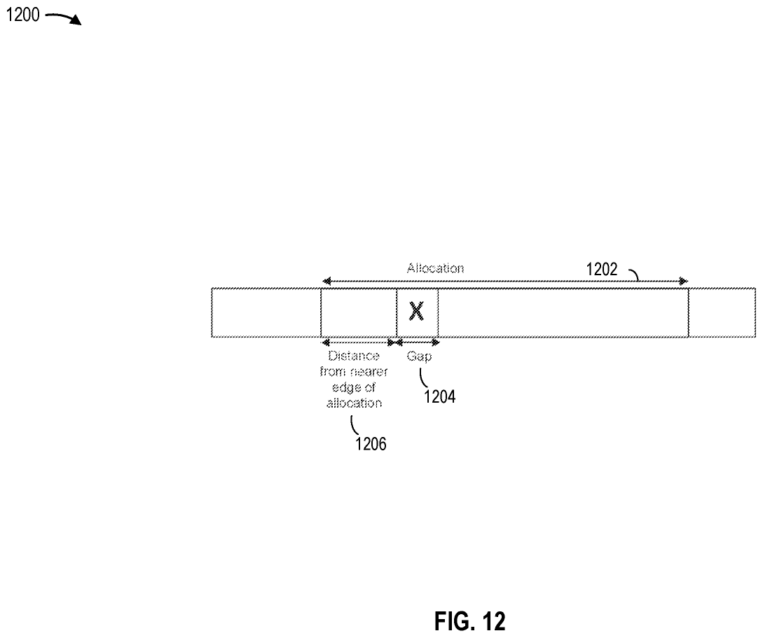

FIG. 12 illustrates a frequency allocation 1202 having a gap 1204, and shows what is meant by a distance of a gap from the nearer edge of the allocation 1206, with reference to the following examples. In some aspects, when there is a single gap in an allocation, if a distance of a gap from the nearer edge of the allocation 1206 (e.g., relative to gap size) is lower than threshold T₃, a Null and Shift scheme may be selected.

In some aspects, when there is a single gap in an allocation, if a distance of a gap from the nearer edge of the allocation (e.g., relative to gap size) is larger than threshold T₃, and if the ratio of (gap size)/(total allocation) is greater than a threshold T₄, a Null and Shift scheme may be selected.

In some aspects, when there is a single gap in an allocation, if a distance of a gap from the nearer edge of the allocation (e.g., relative to gap size) is larger than threshold T₃, and if the ratio of (gap size)/(total allocation) is smaller than threshold T₄, a Null and Append scheme may be selected.

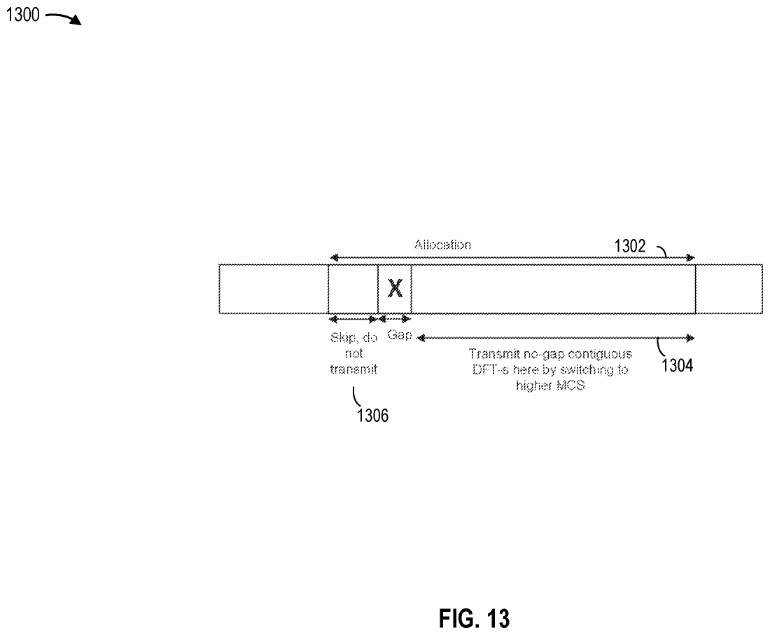

In some aspects, as shown in FIG. 13, when there is a single gap in an allocation 1302, if a distance of a gap from the nearer edge of the allocation (e.g., relative to the distance of the gap from the far edge of the allocation) is lower than a threshold T₅, the device may select to (or be configured to) skip resources (as shown at 1306) and transmit a single carrier waveform with contiguous frequency allocation by selecting a higher MCS, as shown at 1304. In other words, as illustrated in FIG. 13, the single carrier waveform may be made to be more “dense” by increasing an MCS value, allowing the waveform to be transmitted as a no-gap contiguous transmission in a smaller portion of the allocation, which may help mitigate the impact of the discontinuity caused by the gap.

According to certain aspects of the present disclosure (e.g., for SC transmission over fragmented frequency resources or for multiplexing SC transmission with comb-based transmissions), the scheme giving best PAPR may depend on various factors. Some of the factors include total allocation, sizes of gaps in allocation, number of gaps in allocation, distance of a gap from the nearer edge of the allocation, distances in between gaps, resources allocated for the SC waveform, resources allocated to comb-based transmissions, comb structure, comb sparsity, MCS and/or modulation order, UE capability, complexity considerations, and requirements to meet (e.g., EVM or emissions requirements).

A wireless device (e.g., a gNB) can select any of the schemes discussed above, or some other scheme depending on one or a combination of these factors. Similarly, for uplink transmission, the gNB may configure a UE with a scheme depending on one or a combination of these factors and UE capability. In some cases, the rules for selection of the scheme may also depend on the type of single carrier waveform. For example, scheme selection may be different for DFT-s-OFDM compared to SC-QAM, SC Frequency Domain Equalization (SC-FDE), or cyclic prefix (CP)-OFDM.

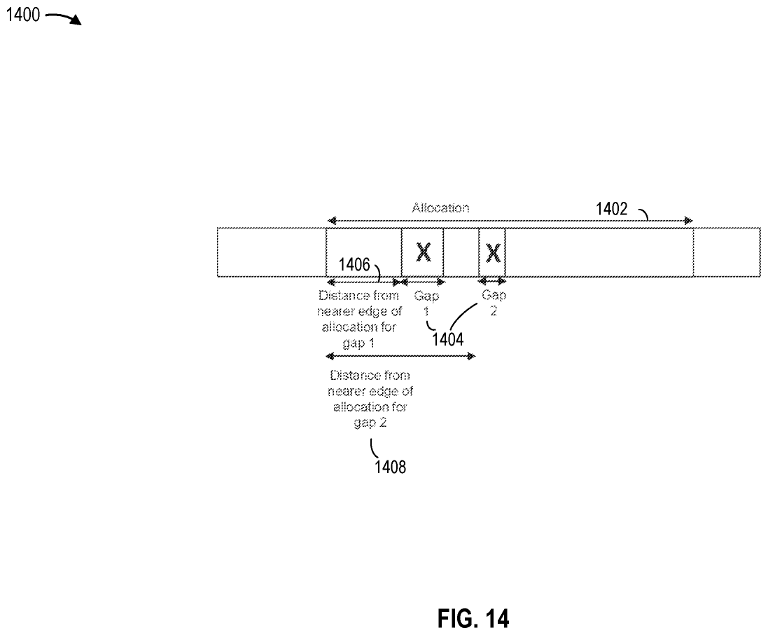

Certain rules for scheme selection may be understood with reference to FIG. 14. For example, in some aspects, when there is more than one gap (e.g., Gap 1 and Gap 2 illustrated at 1404) in an allocation 1402, if the ratio (cumulative gap size)/(total allocation) is smaller than a threshold T₆, and if at least one gap is such that the ratio of its distance from the nearer allocation edge (e.g., distances 1406 or 1408) to its size is greater than threshold T₇ a Null and Append scheme may be selected.

In some aspects, when there is more than one gap (e.g., Gap 1 and Gap 2 illustrated at 1404) in an allocation 1402, if the ratio (cumulative gap size)/(total allocation) is smaller than threshold T₆, and if zero gaps are such that the ratio of their distance from the nearer allocation edge (e.g., distances 1406 or 1408) to their size is greater than threshold T₇, a Null and Shift scheme may be selected.

According to certain aspects, other scheme selection rules may be utilized. The following are illustrative examples of applying criteria/rules for scheme selection for generation of low PAPR DFT-s-OFDM waveforms when allocated frequency resources have gaps (e.g., unavailable resources making the allocation fragmented/not contiguous).

In some aspects, if an MCS is below a threshold T₁ and/or a gap size relative to allocation is less than a threshold T₂, a nulling only or puncturing scheme may be selected. When a nulling only or puncturing scheme is not possible, for example, due to unacceptable EVM degradation, either a Null and Shift scheme, a Null and Append scheme, or some other scheme(s) may be selected.

In some aspects, when there is more than one gap in an allocation, if the ratio (cumulative gap size)/(total allocation) is larger than a threshold T₆, a Null and Shift scheme may be selected.

In some aspects, when gap relative to allocation is very large, a Null and Shift scheme and a Null and Append scheme may lead to intermodulation (e.g., intermodulation distortion (IMD)). In some cases, a device may switch to a different scheme (e.g., in order to reduce intermodulation).

In some aspects (e.g., for single gap or multiple gaps scenarios), when the ratio (cumulative gap size)/(total allocation) is larger than some threshold T₈, a device may select to (or be configured to) switch to a different scheme such as intra-symbol time division multiplexing (TDM) or some other scheme.

In some cases, when a single device wishes to multiplex a single carrier waveform on fragmented resources with a multi carrier waveform such as OFDM, the multi carrier waveform component may cause PAPR regrowth. However, if allocation to multiple carrier (MC) waveform is small, overall PAPR can still be kept reasonably low as compared to multiplexing an MC waveform with an MC waveform.

In some aspects, if the ratio (cumulative gap size)/(total allocation) is smaller than threshold T₉, device may select to (or be configured to) multiplex a multi-carrier waveform such as OFDM in the gap with a single carrier waveform over fragmented resources.

In some aspects, if the ratio (Total number of resources allocated to comb)/(Total allocation of comb+SC waveform) is greater than a threshold T₁, a Null and Shift scheme/mapping may be selected.

In some aspects, if the ratio (Total number of resources allocated to comb)/(Total allocation of comb+SC waveform) is lower than a threshold T₁, a Null and Append scheme/mapping may be selected.

In some aspects, if the ratio (Total number of resources allocated to comb)/(Total allocation of comb+SC waveform) is lower than a threshold T₂ and if MCS for single carrier waveform is smaller than a threshold T₃, a Null only or Puncturing may be selected.

In some aspects, when possible, a Combining scheme (e.g., which will be discussed in greater detail below, with reference to FIG. 25) may be selected in order to reduce computation/complexity.

In some cases, after applying Null and Shift or Null and Append mapping/schemes, the moved/shifted/appended tones may lead to partially filled RBs. In such cases, the partially filled RBs may be left as empty (e.g., empty, partially empty, partially filled), or repeated tones may be used (e.g., with or without pulse-shaping) in the empty resources of the partially filled RBs). In some aspects, gNB may signal how empty RBs (if present) are to be utilized (e.g., using pulse shaping, repetition, skipping, or other techniques).

In some aspects, receiver operations for the schemes described above may depend on the transmission scheme. Therefore, according to certain aspects of the present disclosure, the scheme selected by the transmitting device may be signaled to the receiving device.

In some aspects, for downlink transmission, a gNB may select an appropriate scheme (e.g., to obtain a low PAPR almost continuous SC waveform or to multiplex comb based transmissions with SC waveform). The selected scheme may be signaled to the UE (which may then detect and demodulate the signal, and use the signaled scheme).

In some aspects, for uplink transmission, a gNB may configure a UE with a scheme depending on the various factors discussed in greater detail above, and depending on the UE capability. In such cases, a UE may signal to the gNB its capabilities/which schemes it can support, or a request for the use of a specific scheme. The signaling may be semi-static (e.g., via radio resource control (RRC)) or more dynamic (e.g., using a medium access control (MAC) control element (MAC-CE) or a control channel).

In some aspects, the different thresholds discussed above (e.g., T₁ to T₉) may be specified or configurable. If the thresholds are configurable for example, gNB may signal one or more of the thresholds to the UE and scheme selection may be performed implicitly UE (e.g., after it processes the signaled thresholds). In such cases, the UE may signal its capabilities to the gNB (e.g., since the thresholds may be determined/configured based on the UE capability).

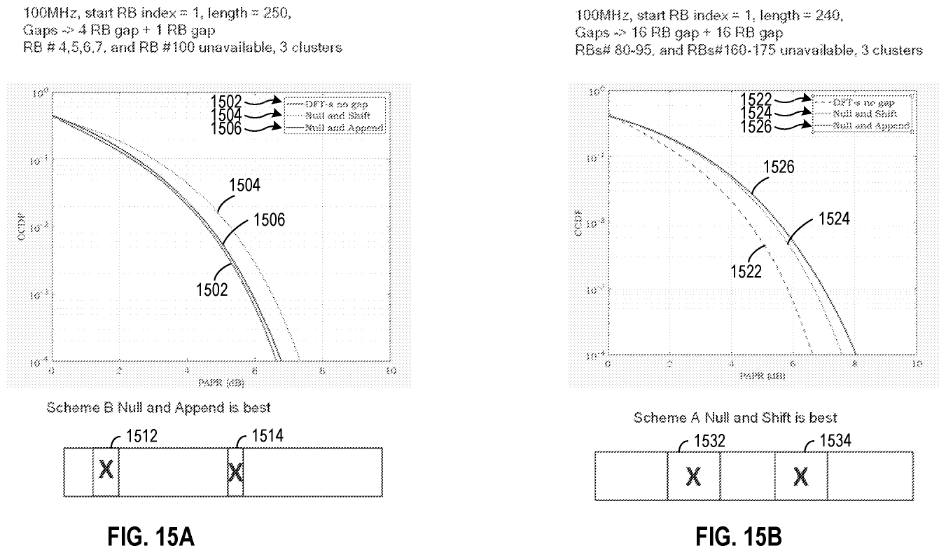

FIGS. 15A and 15B compare the performance of different schemes for managing PAPR for different fragmented FD resource allocation scenarios.

FIG. 15A compares the performance (in terms of PAPR) of different schemes, assuming a total allocation of 250 RBs, with a first gap 1512 of 4 RBs (RB #s 4, 5, 6, and 7) and a second gap 1514 of 1 RB (RB #100). As illustrated, for this fragmented FD resource allocation, a Null and Append scheme (plot 1506), results in a lower PAPR than the Null and Shift scheme (plot 1504). In fact, for this scenario, the PAPR achieved using the Null and Append scheme approaches the PAPR achieved when there is no gap (plot 1502). The Null and Shift scheme may be better suited for other types of fragmented allocations, however, with larger gap sizes.

For example, FIG. 15B compares the performance (in terms of PAPR) of different schemes, assuming a total allocation of 240 RBs, with a first gap 1532 of 16 RBs (RB #s 80-95) and a second gap 1534 of 16 RB (RB #s 160-175). As illustrated, for this fragmented FD resource allocation, the Null and Shift scheme (plot 1524), results in a lower PAPR than the Null and Append scheme (plot 1526). For this scenario, however, both schemes have significantly increased PAPR relative to the PAPR achieved when there is no gap (plot 1522).

As noted above, it may be desirable (e.g., for scheduling flexibility) to multiplex single carrier waveforms with comb-based transmissions (e.g., comb-based transmissions that are scheduled on resources that form gaps in a resource allocation). Such multiplexing may be useful, for example, in scenarios where a single device may transmit multiple comb-based waveforms, but the final multiplexed waveform does not have a comb structure. However, such multiplexing may impact PAPR performance.

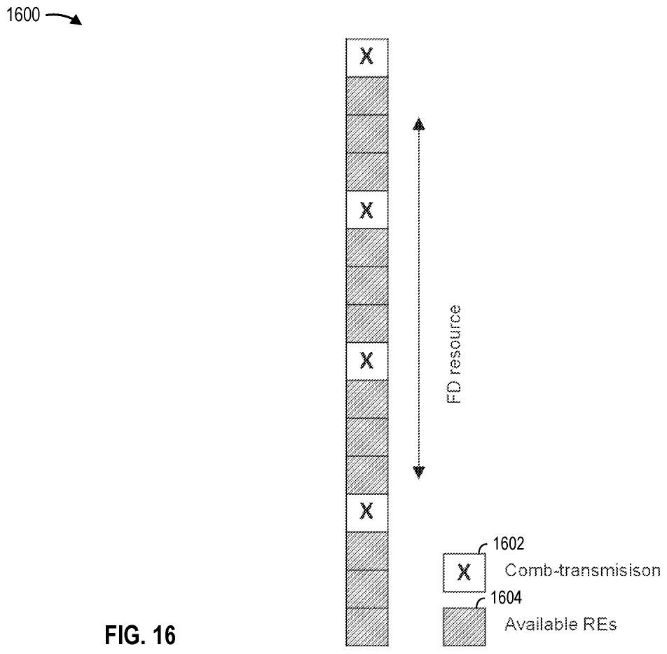

Comb-based transmissions generally refer to transmissions that are periodic in nature (e.g., transmissions whose scheduling exhibit a comb-like structure), and may be understood with reference to the FD resource allocation 1600 of FIG. 16. For example, as shown at 1602, an FD resource may have certain resources (e.g., REs) reserved for comb-transmissions, and certain REs that are available, as shown at 1604. The comb-based transmissions illustrated in FIG. 16 may be described as an SC COMB ¼ waveform, which generally refers to a comb-based waveform having a comb-transmissions of a periodicity where every fourth subcarrier in the frequency domain is allocated to a comb-transmission.

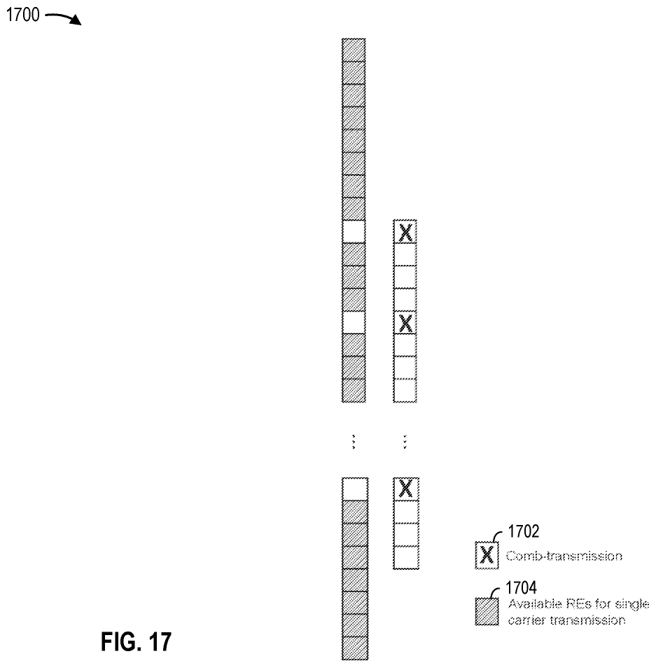

As noted above, aspects of the present disclosure provide techniques that may allow SC waveforms to be multiplexed with comb-based transmissions, while maintaining a low PAPR property of a resulting waveform. This multiplexing may be understood with reference to the FD resource allocation 1700 of FIG. 17.

For example, as illustrated, when multiplexing an SC waveform with comb-based transmissions, the resulting waveform may have reserved REs (e.g., reserved for comb-transmissions), as illustrated at 1702, while other REs 1704 are available for SC transmission. The comb-transmissions are unavailable resources in this context, and may be considered as such. For example, certain schemes, described in further detail above with reference to FIGS. 9-11, may be applied to map the SC waveform (e.g., around the comb-transmissions with which the SC waveform has been multiplexed) to available resources, while maintaining a low PAPR property of the resulting waveform.

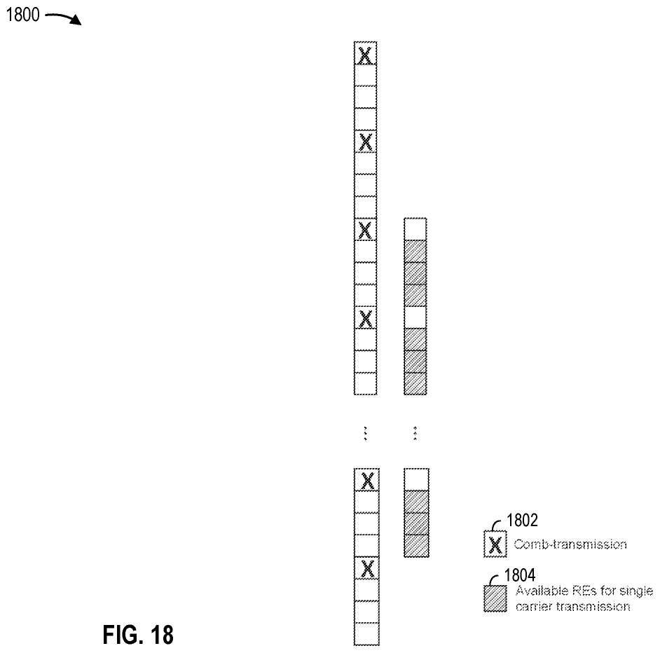

In the scenario illustrated in FIG. 17, the comb-based transmissions are strictly within the frequency allocation. In some scenarios, however, comb-based transmissions may extend outside of the frequency allocation on one side or both sides. Such a scenario is illustrated in the FD resource allocation 1800 of FIG. 18.

For example, as illustrated in FIG. 18, the REs 1802 reserved for comb-transmissions extend beyond the allocation of available REs 1804 for the SC waveform. In such cases, the selected scheme may account for the comb-transmissions that extend beyond the allocation. For example, a scheme (e.g., such as a Null and Append scheme) which utilizes resources that extend beyond the allocation for mapping DFT-precoded symbols/tones whose locations in frequency correspond to unavailable resources may perform appending (e.g., or shifting) while considering these comb-transmissions that extend beyond the allocation. These scenarios (e.g., comb-based transmissions are strictly within the frequency allocation and comb-based transmissions extending outside of the frequency allocation) will be discussed in greater detail below, with specific examples applying various schemes (e.g., Null and Shift, Null and Append, etc.).

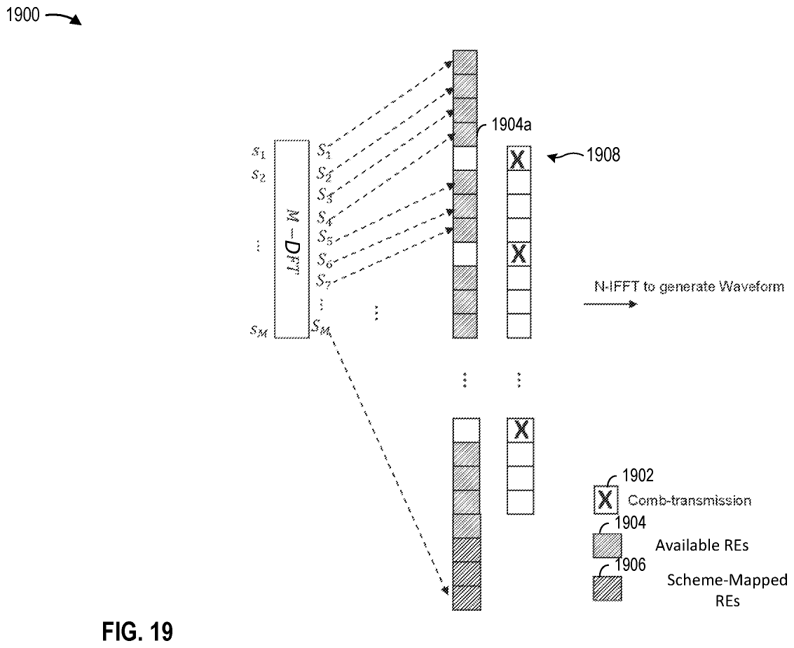

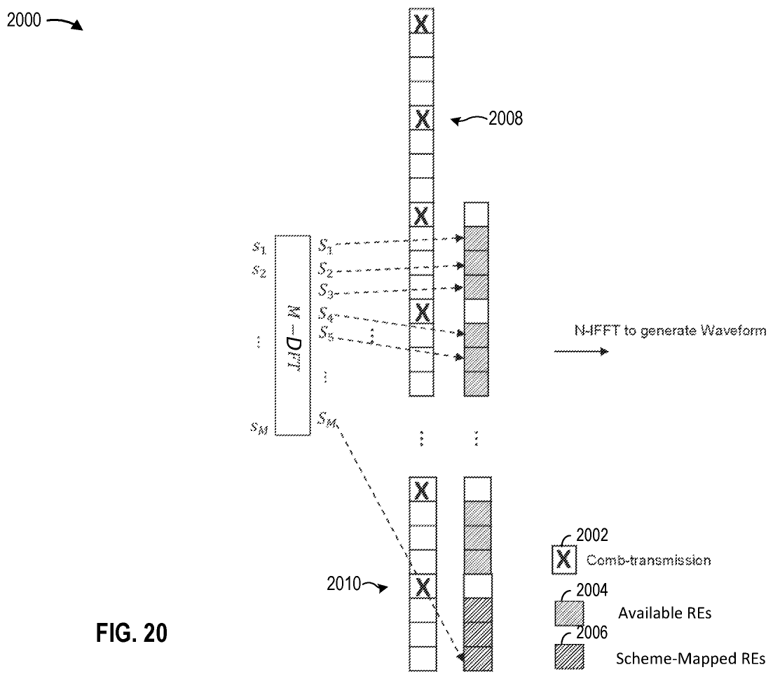

FIGS. 19 and 20 illustrate examples of how the Null and Shift scheme (described above with reference to FIG. 9) may be applied to scenarios involving multiplexing of an SC waveform with comb-based transmissions. For example, as illustrated in FIG. 19, a frequency allocation 1900 may include available REs 1904, and may be fragmented due to resources reserved for the comb-transmissions 1902. In the example illustrated in FIG. 19, the comb-transmissions are strictly within the frequency allocation. Thus, DFT-precoded data/tones are mapped in a sequential or serial manner to available resources while skipping (e.g., not transmitting on) unavailable frequency resources (e.g., the comb-transmissions) within the allocation. For example, as shown, after S₄ is mapped to an available RE 1904a, an unavailable frequency resource 1908 is skipped. S₅, which would have otherwise been mapped to unavailable resource 1908, is instead shifted in a sequential manner to the next available resources. As illustrated, DFT-precoded symbols that follow (e.g., S₆ through S_{M}) are similarly mapped sequentially to available resources, including scheme-mapped REs 1906 (e.g., REs outside of the original frequency allocation to which symbols are mapped using the selected scheme), following the shifted mapping of S₅.

FIG. 20 illustrates a similar example of an FD resource allocation 2000 where the comb-transmissions 2002 extend beyond the frequency allocation (e.g., in frequency locations before and/or after the allocation) of available REs 2004. For example, as illustrated at 2008, a comb-transmission occurs before the allocation. Further, as illustrated at 2010, a comb-based transmission occurs after the allocation. As illustrated in FIG. 20 (similarly to FIG. 19), DFT-precoded data/tones are mapped in a sequential or serial manner to available resources while skipping (e.g., not transmitting on) unavailable frequency resources (e.g., the comb-transmissions), including comb-transmissions that occur outside of the allocation. For example, as shown, the unavailable frequency resource corresponding to comb-transmission 2010 is skipped, and the remaining DFT-precoded data/tones through S_{M} are mapped sequentially thereafter.

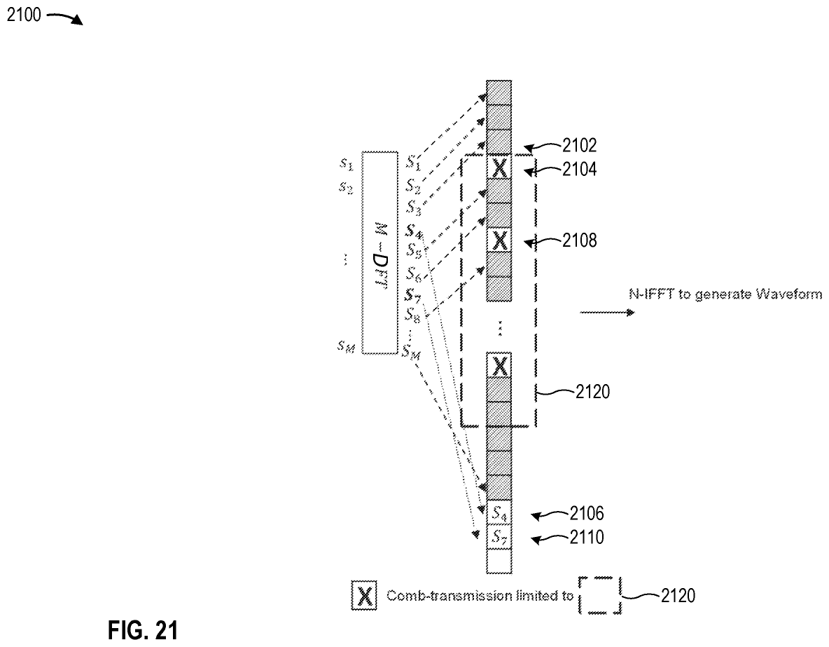

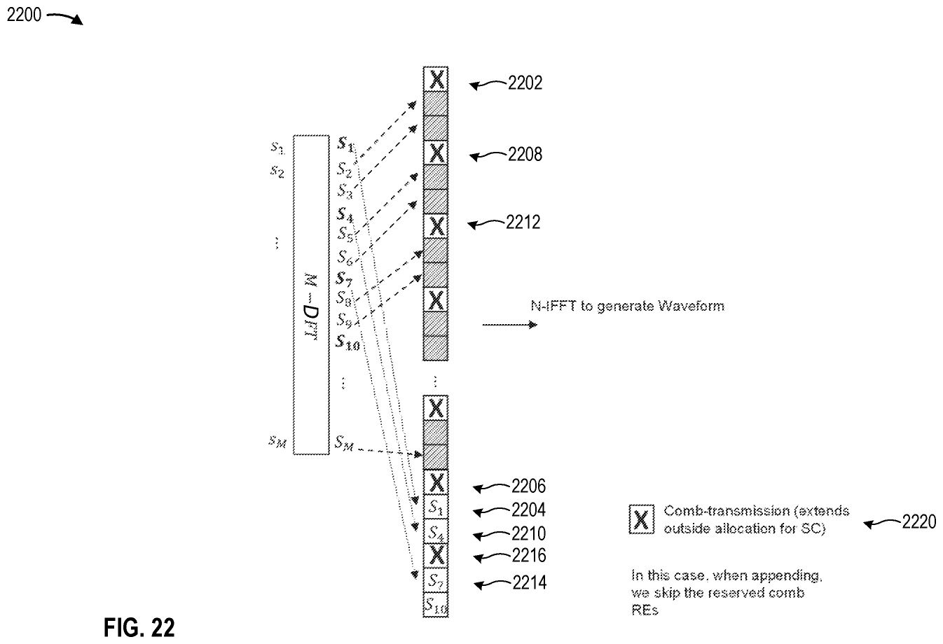

FIGS. 21 and 22 illustrate examples of how the Null and Append scheme (described above with reference to FIG. 10) may be applied to scenarios involving multiplexing of an SC waveform with comb-based transmissions. For example, as illustrated in FIG. 21, a frequency allocation 2100 may be fragmented due to resources reserved for comb-transmissions. In the example illustrated in FIG. 21, the comb-transmissions are strictly within the frequency allocation as shown at 2120. Thus, DFT-precoded symbols/tones whose locations in frequency correspond to unavailable resources may be appended to the ends of the allocation while skipping (e.g., not transmitting on) unavailable frequency resources (e.g., the comb-transmissions) within the allocation.

For example, as shown, after S₃ is mapped to an available RE 2102, an unavailable frequency resource 2104 is skipped. S₄, which would have otherwise been mapped to unavailable resource 2104, is instead appended to the next RE 2106 after the end of the allocation. Similarly, S₇, which would have otherwise been mapped to unavailable resource 2108, is instead appended to next RE 2110 after the end of the allocation (and after RE 2106 to which S₄ was mapped).

In some cases, using a Null and Append scheme, the DFT-precoded symbols whose locations in frequency correspond to unavailable resources (e.g., S₄ and S₇ in the example illustrated in FIG. 21) may be appended to the beginning of the allocation or to both ends of the allocation. In other words, as noted above, when using Null and Append scheme/mapping, tones may be appended on one side only or divided into two groups, each group being appended to a side of the allocation.

FIG. 22 illustrates a similar example, of an FD resource allocation 2200 where, as illustrated at 2220, the comb-transmissions extend beyond the frequency allocation (e.g., in frequency locations before and/or after the allocation) of available REs. For example, as illustrated at 2206 and 2214, comb-transmissions occur after the allocation. As illustrated in FIG. 22 (similarly to FIG. 21), DFT-precoded symbols/tones whose locations in frequency correspond to unavailable resources may be appended to the ends of the allocation while skipping (e.g., not transmitting on) unavailable frequency resources (e.g., the comb-transmissions) including comb-transmissions that occur outside of the allocation and inside of the allocation. For example, as shown, S₁, which would otherwise have been mapped to unavailable resource 2202, is instead appended to the next available RE 2204 after the end of the allocation. As illustrated, when mapping S₁, unavailable resource 2206 (e.g., unavailable due to the comb-transmission), which occurs after the end of the allocation, is skipped.

Similarly, S₄, which would have otherwise been mapped to unavailable resource 2208, is instead appended to the next available RE 2210 after the end of the allocation (and after RE 2204 to which S₁ was mapped). Similarly, S₇, which would have otherwise been mapped to unavailable resource 2212, is instead appended to the next available RE 2214 after the end of the allocation (and after REs 2204 and 2210 to which S₁ and S₄ were mapped respectively). As illustrated, when mapping S₇, unavailable resource 2216, which occurs after the end of the allocation, is skipped.

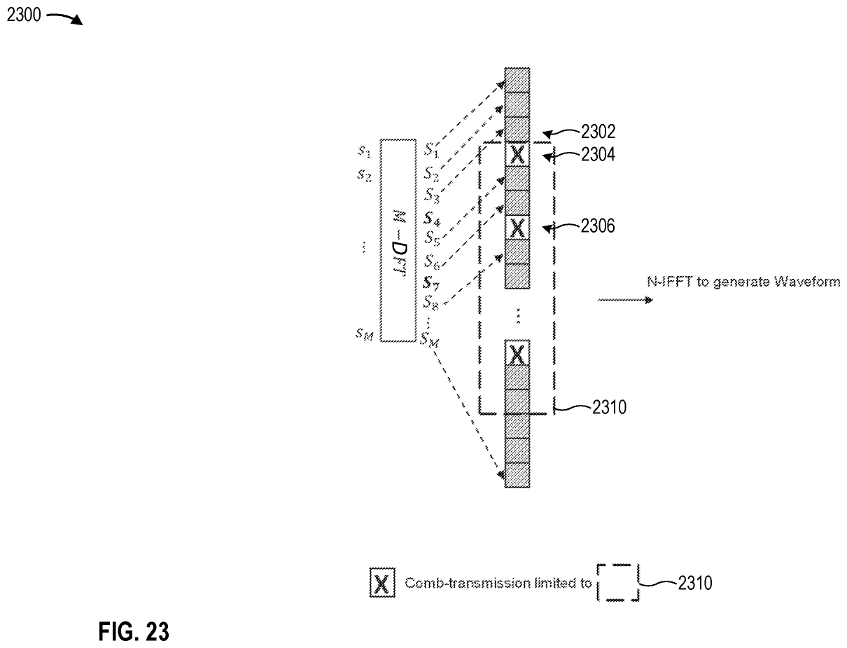

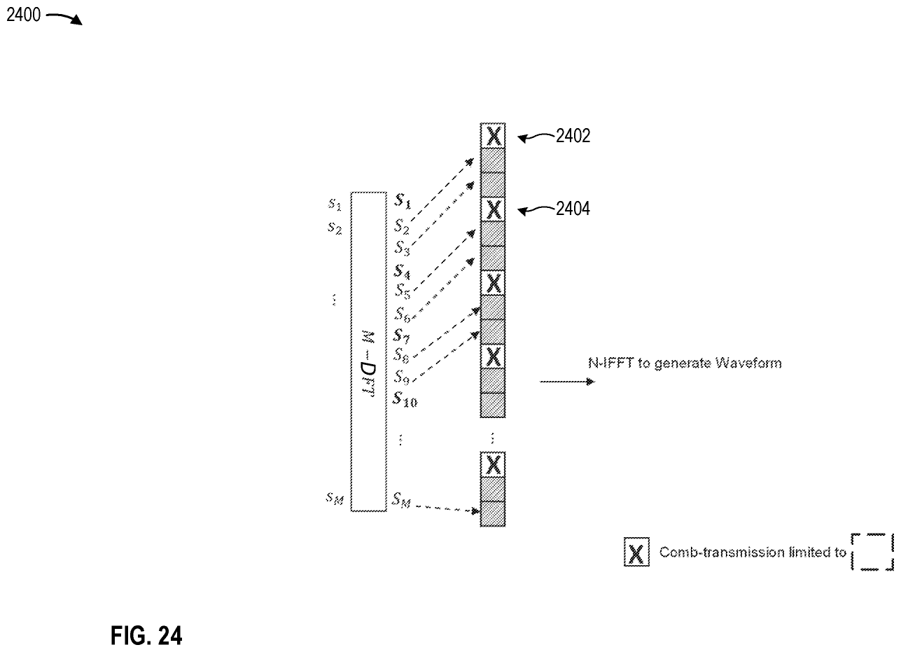

FIGS. 23 and 24 illustrate examples of how the Null only (puncturing) scheme (described above with reference to FIG. 11) may be applied to scenarios involving multiplexing of an SC waveform with comb-based transmissions. For example, as illustrated in FIG. 23, a frequency allocation 2300 may be fragmented due to resources reserved for the comb-transmissions. In the example illustrated in FIG. 23, the comb-transmissions are strictly within the frequency allocation, as shown at 2310. Thus, DFT-precoded data/tones are mapped as they would be without a scheme, while skipping DFT-precoded data/tones (e.g., not mapping/transmitting tones) that would otherwise be mapped to unavailable frequency resources (e.g., the comb-transmissions) within the allocation.

For example, as shown, after S₃ is mapped to an available RE 2302, an unavailable frequency resource 2304 is skipped. S₄, which would have otherwise been mapped to unavailable resource 2304, is instead not mapped (e.g., not transmitted) at all. As illustrated, DFT-precoded symbols that follow (e.g., S₄ through S_{M}) are similarly mapped, as they normally would be (e.g., without using a scheme), to available resources, while symbols that would be mapped to unavailable frequency resources are not mapped/transmitted. For example, S₇, which would have otherwise been mapped to unavailable resource 2306, is instead not mapped/transmitted at all.

FIG. 24 illustrates a similar example of an FD resource allocation 2400 where the comb-transmissions extend beyond the frequency allocation (e.g., in frequency locations before and/or after the allocation) of available REs. For example, comb-transmission 2402 occurs before the allocation. As illustrated in FIG. 24 (similarly to FIG. 23), DFT-precoded symbols/tones whose locations in frequency correspond to unavailable resources may be skipped. For example, S₄, which would have otherwise been mapped to unavailable resource 2404, is instead not mapped (e.g., not transmitted) at all.

While this Null only scheme may lead to EVM degradation, it may still be a viable scheme in certain scenarios. As noted above, the viability of this scheme may depend on a multitude of factors such as MCS, number of unavailable resources, comb sparsity, and requirements (e.g., EVM or emissions requirements).

FIG. 25 illustrates DFT-s-OFDM generation via a Combining scheme, which may be used in scenarios involving comb-based transmissions. As illustrated, using a combining scheme, multiple comb-based single carrier waveforms may be combined. For example, an SC COMB ½ waveform (e.g., a waveform where every second subcarrier in the frequency domain is allocated to a comb transmission), as illustrated at 2520, may be combined with an SC COMB ¼ waveform (e.g., a waveform where every fourth subcarrier in the frequency domain is allocated to a comb transmission), as illustrated at 2510, to obtain an SC COMB ¾ waveform (e.g., a waveform where three of every four subcarriers in the frequency domain are allocated to a comb transmission), as illustrated at 2530.

Using such a Combining scheme, instead of one large DFT (e.g., compared to a Shifting/Appending/puncturing based scheme), data may be divided into different groups, where each group undergoes a smaller sized DFT. This may use a lesser number of total computations (e.g., additions and multiplications) in many cases, reducing complexity and processing overhead, which may result in reduced power consumption. For example, in a scenario where 12M data symbols are to be transmitted as an SC COMB ¾ waveform, Shifting based schemes/mapping or Append based schemes/mapping may use a 12M-point DFT, whereas SC COMB ½+SC COMB ¼ may only use one 4M-point DFT and one 8M-point DFT.

### Example Operations

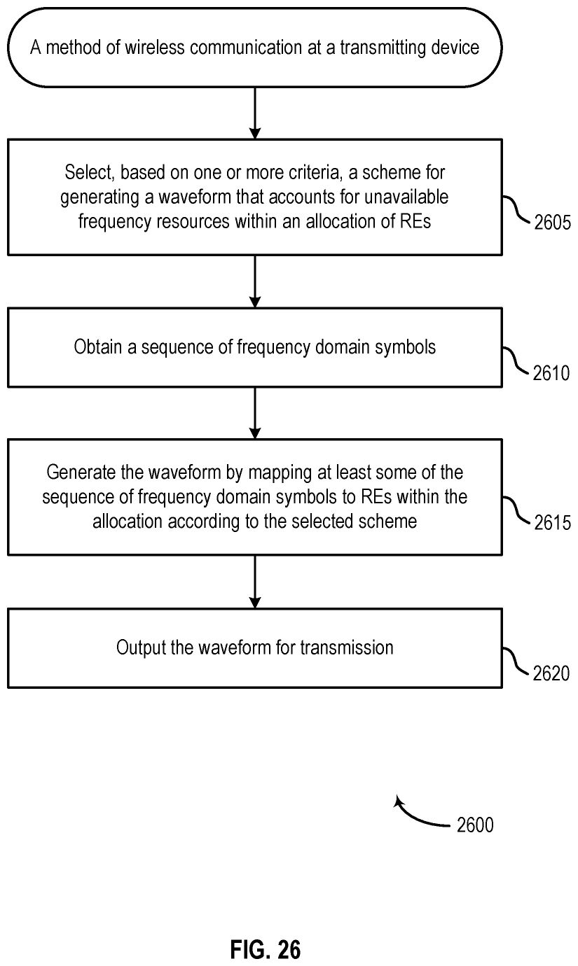

FIG. 26 shows an example of a method 2600 of wireless communication at a transmitting device. In some examples, the transmitting device is a user equipment, such as a UE 104 of FIGS. 1 and 3. In some examples, the transmitting device is a network entity, such as a BS 102 of FIGS. 1 and 3, or a disaggregated base station as discussed with respect to FIG. 2.

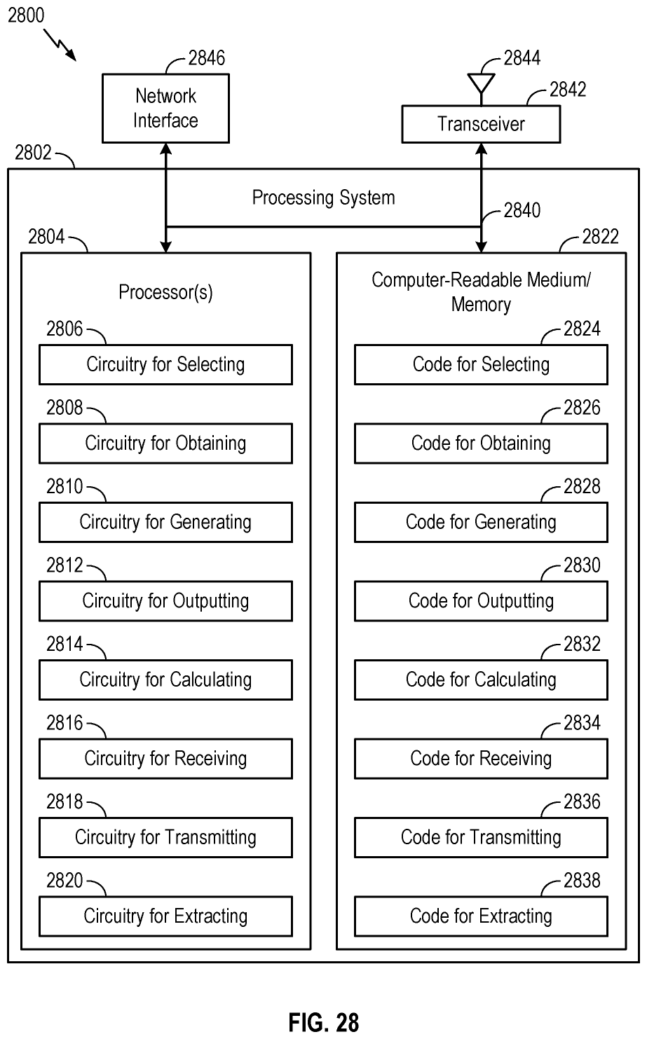

Method 2600 begins at step 2605 with selecting, based on one or more criteria, a scheme for generating a waveform that accounts for unavailable frequency resources within an allocation of REs. In some cases, the operations of this step refer to, or may be performed by, circuitry for selecting and/or code for selecting as described with reference to FIG. 28.

Method 2600 then proceeds to step 2610 with obtaining a sequence of frequency domain symbols. In some cases, the operations of this step refer to, or may be performed by, circuitry for obtaining and/or code for obtaining as described with reference to FIG. 28.

Method 2600 then proceeds to step 2615 with generating the waveform by mapping at least some of the sequence of frequency domain symbols to REs within the allocation according to the selected scheme. In some cases, the operations of this step refer to, or may be performed by, circuitry for generating and/or code for generating as described with reference to FIG. 28.

Method 2600 then proceeds to step 2620 with outputting the waveform for transmission. In some cases, the operations of this step refer to, or may be performed by, circuitry for outputting and/or code for outputting as described with reference to FIG. 28.

In some aspects, the scheme for generating the waveform is selected from at least two schemes including at least one of: a first scheme that shifts at least some of the frequency domain symbols, in order, to avoid mapping to the unavailable frequency resources; a second scheme that appends at least a first frequency domain symbol of the sequence of frequency domain symbols to at least one end of the allocation of REs in order to avoid mapping to the unavailable frequency resources; or a third scheme that involves skipping transmission of one or more frequency domain symbols that map to the unavailable frequency resources.

In some aspects, the unavailable frequency resources comprise one or more unavailable REs that form one or more gaps in the allocation of REs; and the selected scheme avoids the unavailable REs when mapping the sequence of frequency domain symbols to REs.

In some aspects, the one or more unavailable REs are allocated for comb-based transmissions.

In some aspects, the one or more criteria are based on at least one of the following parameters: a number of REs, of the allocation of REs, that are available for outputting the waveform; a number of the one or more unavailable REs; a size of at least one of the one or more gaps; a quantity of the one or more gaps; a distance of at least one of the one or more gaps from an edge of the allocation; at least one distance between the one or more gaps; or at least one threshold value.

In some aspects, the method 2600 further includes calculating a ratio based on two or more of the parameters, wherein the one or more criteria specify selection of a scheme based on a comparison of the ratio to the at least one threshold value. In some cases, the operations of this step refer to, or may be performed by, circuitry for calculating and/or code for calculating as described with reference to FIG. 28.

In some aspects, the ratio comprises a ratio of the number of the one or more unavailable REs to a sum of the number of REs of an allocation of REs available for outputting the waveform and the number of the one or more unavailable REs.

In some aspects, the method 2600 further includes receiving signaling indicating the at least one threshold value. In some cases, the operations of this step refer to, or may be performed by, circuitry for receiving and/or code for receiving as described with reference to FIG. 28.

In some aspects, the method 2600 further includes transmitting signaling indicating a capability of the transmitting device to support selecting the scheme based on the one or more criteria. In some cases, the operations of this step refer to, or may be performed by, circuitry for transmitting and/or code for transmitting as described with reference to FIG. 28.

In some aspects, the signaling indicating a capability is transmitted using at least one of: RRC signaling; or a MAC-CE.

In some aspects, the one or more criteria are based on at least one of: a MCS associated with the waveform; a type of the waveform; a capability of a receiving device; or at least one parameter related to performance of the transmitting device.

In some aspects, the method 2600 further includes obtaining an indication of a scheme for generating a waveform that accounts for unavailable frequency resources, wherein the selection of the scheme is based on the indication. In some cases, the operations of this step refer to, or may be performed by, circuitry for obtaining and/or code for obtaining as described with reference to FIG. 28.

In some aspects, the generated waveform comprises a single carrier waveform.

In some aspects, the method 2600 further includes transmitting signaling indicating the selected scheme to a receiving device. In some cases, the operations of this step refer to, or may be performed by, circuitry for transmitting and/or code for transmitting as described with reference to FIG. 28.

In one aspect, method 2600, or any aspect related to it, may be performed by an apparatus, such as communications device 2800 of FIG. 28, which includes various components operable, configured, or adapted to perform the method 2600. Communications device 2800 is described below in further detail.

Note that FIG. 26 is just one example of a method, and other methods including fewer, additional, or alternative steps are possible consistent with this disclosure.

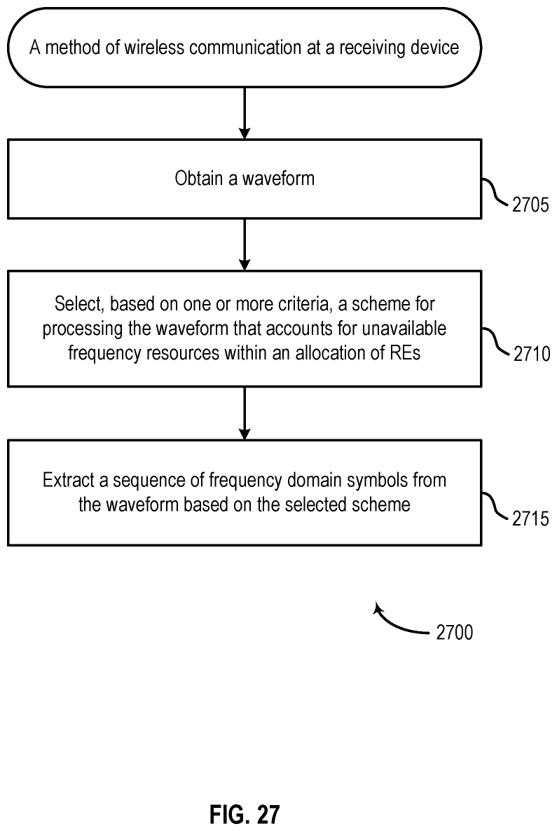

FIG. 27 shows an example of a method 2700 of wireless communication at a receiving device. In some examples, the receiving device is a user equipment, such as a UE 104 of FIGS. 1 and 3. In some examples, the receiving device is a network entity, such as a BS 102 of FIGS. 1 and 3, or a disaggregated base station as discussed with respect to FIG. 2.

Method 2700 begins at step 2705 with obtaining a waveform. In some cases, the operations of this step refer to, or may be performed by, circuitry for obtaining and/or code for obtaining as described with reference to FIG. 28.

Method 2700 then proceeds to step 2710 with selecting, based on one or more criteria, a scheme for processing the waveform that accounts for unavailable frequency resources within an allocation of REs. In some cases, the operations of this step refer to, or may be performed by, circuitry for selecting and/or code for selecting as described with reference to FIG. 28.

Method 2700 then proceeds to step 2715 with extracting a sequence of frequency domain symbols from the waveform based on the selected scheme. In some cases, the operations of this step refer to, or may be performed by, circuitry for extracting and/or code for extracting as described with reference to FIG. 28.

In some aspects, the scheme for generating the waveform is selected from at least two schemes including at least one of: a first scheme that shifts at least some of the frequency domain symbols, in order, to avoid mapping to the unavailable frequency resources; a second scheme that appends at least a first frequency domain symbol of the sequence of frequency domain symbols to at least one end of the allocation of REs in order to avoid mapping to the unavailable frequency resources; or a third scheme that involves skipping transmission of one or more frequency domain symbols that map to the unavailable frequency resources.

In some aspects, the unavailable frequency resources comprise one or more unavailable REs that form one or more gaps in the allocation of REs; and the selected scheme avoids the unavailable REs when demapping the sequence of frequency domain symbols from REs.

In some aspects, the one or more unavailable REs are allocated for comb-based transmissions.

In some aspects, the one or more criteria are based on at least one of the following parameters: a number of REs, of the allocation of REs, that are available for outputting the waveform; a number of the one or more unavailable REs; a size of at least one of the one or more gaps; a quantity of the one or more gaps; a distance of at least one of the one or more gaps from an edge of the allocation; at least one distance between the one or more gaps; or at least one threshold value.

In some aspects, the method 2700 further includes calculating a ratio based on two or more of the parameters, wherein the one or more criteria specify selection of a scheme based on a comparison of the ratio to the at least one threshold value. In some cases, the operations of this step refer to, or may be performed by, circuitry for calculating and/or code for calculating as described with reference to FIG. 28.

In some aspects, the ratio comprises a ratio of the number of the one or more unavailable REs to a sum of the number of REs of an allocation of REs available for outputting the waveform and the number of the one or more unavailable REs.

In some aspects, the method 2700 further includes transmitting signaling indicating the at least one threshold value. In some cases, the operations of this step refer to, or may be performed by, circuitry for transmitting and/or code for transmitting as described with reference to FIG. 28.

In some aspects, the method 2700 further includes receiving signaling indicating a capability of a transmitting device to support selecting the scheme based on the one or more criteria. In some cases, the operations of this step refer to, or may be performed by, circuitry for receiving and/or code for receiving as described with reference to FIG. 28.

In some aspects, the signaling indicating the capability is received using at least one of: RRC signaling; or a MAC-CE.

In some aspects, the one or more criteria are based on at least one of: a MCS associated with the waveform; a type of the waveform; a capability of the receiving device; or at least one parameter related to performance of the transmitting device.

In some aspects, the method 2700 further includes transmitting an indication of a scheme for generating a waveform that accounts for unavailable frequency resources, wherein the selection of the scheme is based on the indication. In some cases, the operations of this step refer to, or may be performed by, circuitry for transmitting and/or code for transmitting as described with reference to FIG. 28.

In some aspects, the generated waveform comprises a single carrier waveform.

In some aspects, the method 2700 further includes receiving signaling indicating the selected scheme from a transmitting device. In some cases, the operations of this step refer to, or may be performed by, circuitry for receiving and/or code for receiving as described with reference to FIG. 28.

In one aspect, method 2700, or any aspect related to it, may be performed by an apparatus, such as communications device 2800 of FIG. 28, which includes various components operable, configured, or adapted to perform the method 2700. Communications device 2800 is described below in further detail.

Note that FIG. 27 is just one example of a method, and other methods including fewer, additional, or alternative steps are possible consistent with this disclosure.

### Example Communications Device

FIG. 28 depicts aspects of an example communications device 2800. In some aspects, communications device 2800 is a user equipment, such as UE 104 described above with respect to FIGS. 1 and 3. In some aspects, communications device 2800 is a network entity, such as BS 102 of FIGS. 1 and 3, or a disaggregated base station as discussed with respect to FIG. 2.

The communications device 2800 includes a processing system 2802 coupled to the transceiver 2842 (e.g., a transmitter and/or a receiver). In some aspects (e.g., when communications device 2800 is a network entity), processing system 2802 may be coupled to a network interface 2846 that is configured to obtain and send signals for the communications device 2800 via communication link(s), such as a backhaul link, midhaul link, and/or fronthaul link as described herein, such as with respect to FIG. 2. The transceiver 2842 is configured to transmit and receive signals for the communications device 2800 via the antenna 2844, such as the various signals as described herein. The processing system 2802 may be configured to perform processing functions for the communications device 2800, including processing signals received and/or to be transmitted by the communications device 2800.

The processing system 2802 includes one or more processors 2804. In various aspects, the one or more processors 2804 may be representative of one or more of receive processor 358, transmit processor 364, TX MIMO processor 366, and/or controller/processor 380, as described with respect to FIG. 3. In various aspects, one or more processors 2804 may be representative of one or more of receive processor 338, transmit processor 320, TX MIMO processor 330, and/or controller/processor 340, as described with respect to FIG. 3. The one or more processors 2804 are coupled to a computer-readable medium/memory 2822 via a bus 2840. In certain aspects, the computer-readable medium/memory 2822 is configured to store instructions (e.g., computer-executable code) that when executed by the one or more processors 2804, cause the one or more processors 2804 to perform the method 2600 described with respect to FIG. 26, or any aspect related to it; and the method 2700 described with respect to FIG. 27, or any aspect related to it. Note that reference to a processor performing a function of communications device 2800 may include one or more processors 2804 performing that function of communications device 2800.

In the depicted example, computer-readable medium/memory 2822 stores code (e.g., executable instructions), such as code for selecting 2824, code for obtaining 2826, code for generating 2828, code for outputting 2830, code for calculating 2832, code for receiving 2834, code for transmitting 2836, and code for extracting 2838. Processing of the code for selecting 2824, code for obtaining 2826, code for generating 2828, code for outputting 2830, code for calculating 2832, code for receiving 2834, code for transmitting 2836, and code for extracting 2838 may cause the communications device 2800 to perform the method 2600 described with respect to FIG. 26, or any aspect related to it; and the method 2700 described with respect to FIG. 27, or any aspect related to it.

The one or more processors 2804 include circuitry configured to implement (e.g., execute) the code stored in the computer-readable medium/memory 2822, including circuitry for selecting 2806, circuitry for obtaining 2808, circuitry for generating 2810, circuitry for outputting 2812, circuitry for calculating 2814, circuitry for receiving 2816, circuitry for transmitting 2818, and circuitry for extracting 2820. Processing with circuitry for selecting 2806, circuitry for obtaining 2808, circuitry for generating 2810, circuitry for outputting 2812, circuitry for calculating 2814, circuitry for receiving 2816, circuitry for transmitting 2818, and circuitry for extracting 2820 may cause the communications device 2800 to perform the method 2600 described with respect to FIG. 26, or any aspect related to it; and the method 2700 described with respect to FIG. 27, or any aspect related to it.

Various components of the communications device 2800 may provide means for performing the method 2600 described with respect to FIG. 26, or any aspect related to it; and the method 2700 described with respect to FIG. 27, or any aspect related to it. For example, means for transmitting, sending or outputting for transmission may include transceivers 354 and/or antenna(s) 352 of the UE 104 illustrated in FIG. 3, transceivers 332 and/or antenna(s) 334 of the BS 102 illustrated in FIG. 3, and/or the transceiver 2842 and the antenna 2844 of the communications device 2800 in FIG. 28. Means for receiving or obtaining may include transceivers 354 and/or antenna(s) 352 of the UE 104 illustrated in FIG. 3, transceivers 332 and/or antenna(s) 334 of the BS 102 illustrated in FIG. 3, and/or the transceiver 2842 and the antenna 2844 of the communications device 2800 in FIG. 28.

### EXAMPLE CLAUSES

Implementation examples are described in the following numbered clauses:

Clause 1: A method of wireless communication at a transmitting device, comprising: selecting, based on one or more criteria, a scheme for generating a waveform that accounts for unavailable frequency resources within an allocation of REs; obtaining a sequence of frequency domain symbols; generating the waveform by mapping at least some of the sequence of frequency domain symbols to REs within the allocation according to the selected scheme; and outputting the waveform for transmission.

Clause 2: The method of Clause 1, wherein the scheme for generating the waveform is selected from at least two schemes including at least one of: a first scheme that shifts at least some of the frequency domain symbols, in order, to avoid mapping to the unavailable frequency resources; a second scheme that appends at least a first frequency domain symbol of the sequence of frequency domain symbols to at least one end of the allocation of REs in order to avoid mapping to the unavailable frequency resources; or a third scheme that involves skipping transmission of one or more frequency domain symbols that map to the unavailable frequency resources.

Clause 3: The method of any one of Clauses 1 and 2, wherein: the unavailable frequency resources comprise one or more unavailable REs that form one or more gaps in the allocation of REs; and the selected scheme avoids the unavailable REs when mapping the sequence of frequency domain symbols to REs.

Clause 4: The method of Clause 3, wherein the one or more unavailable REs are allocated for comb-based transmissions.

Clause 5: The method of Clause 3, wherein the one or more criteria are based on at least one of the following parameters: a number of REs, of the allocation of RES, that are available for outputting the waveform; a number of the one or more unavailable REs; a size of at least one of the one or more gaps; a quantity of the one or more gaps; a distance of at least one of the one or more gaps from an edge of the allocation; at least one distance between the one or more gaps; or at least one threshold value.

Clause 6: The method of Clause 5, further comprising: calculating a ratio based on two or more of the parameters, wherein the one or more criteria specify selection of a scheme based on a comparison of the ratio to the at least one threshold value.

Clause 7: The method of Clause 6, wherein the ratio comprises a ratio of the number of the one or more unavailable REs to a sum of the number of REs of an allocation of REs available for outputting the waveform and the number of the one or more unavailable REs.

Clause 8: The method of Clause 6, further comprising receiving signaling indicating the at least one threshold value.

Clause 9: The method of any one of Clauses 1-8, further comprising transmitting signaling indicating a capability of the transmitting device to support selecting the scheme based on the one or more criteria.

Clause 10: The method of Clause 9, wherein the signaling indicating a capability is transmitted using at least one of: RRC signaling; or a MAC-CE.

Clause 11: The method of any one of Clauses 1-10, wherein the one or more criteria are based on at least one of: a MCS associated with the waveform; a type of the waveform; a capability of a receiving device; or at least one parameter related to performance of the transmitting device.

Clause 12: The method of any one of Clauses 1-11, further comprising obtaining an indication of a scheme for generating a waveform that accounts for unavailable frequency resources, wherein the selection of the scheme is based on the indication.

Clause 13: The method of any one of Clauses 1-12, wherein the generated waveform comprises a single carrier waveform.

Clause 14: The method of any one of Clauses 1-13, further comprising transmitting signaling indicating the selected scheme to a receiving device.

Clause 15: A method of wireless communication at a receiving device, comprising: obtaining a waveform; selecting, based on one or more criteria, a scheme for processing the waveform that accounts for unavailable frequency resources within an allocation of REs; and extracting a sequence of frequency domain symbols from the waveform based on the selected scheme.

Clause 16: The method of Clause 15, wherein the scheme for generating the waveform is selected from at least two schemes including at least one of: a first scheme that shifts at least some of the frequency domain symbols, in order, to avoid mapping to the unavailable frequency resources; a second scheme that appends at least a first frequency domain symbol of the sequence of frequency domain symbols to at least one end of the allocation of REs in order to avoid mapping to the unavailable frequency resources; or a third scheme that involves skipping transmission of one or more frequency domain symbols that map to the unavailable frequency resources.

Clause 17: The method of any one of Clauses 15 and 16, wherein: the unavailable frequency resources comprise one or more unavailable REs that form one or more gaps in the allocation of REs; and the selected scheme avoids the unavailable REs when demapping the sequence of frequency domain symbols from REs.

Clause 18: The method of Clause 17, wherein the one or more unavailable REs are allocated for comb-based transmissions.

Clause 19: The method of Clause 17, wherein the one or more criteria are based on at least one of the following parameters: a number of REs, of the allocation of REs, that are available for outputting the waveform; a number of the one or more unavailable REs; a size of at least one of the one or more gaps; a quantity of the one or more gaps; a distance of at least one of the one or more gaps from an edge of the allocation; at least one distance between the one or more gaps; or at least one threshold value.

Clause 20: The method of Clause 19, further comprising: calculating a ratio based on two or more of the parameters, wherein the one or more criteria specify selection of a scheme based on a comparison of the ratio to the at least one threshold value.

Clause 21: The method of Clause 20, wherein the ratio comprises a ratio of the number of the one or more unavailable REs to a sum of the number of REs of an allocation of REs available for outputting the waveform and the number of the one or more unavailable REs.

Clause 22: The method of Clause 20, further comprising transmitting signaling indicating the at least one threshold value.

Clause 23: The method of any one of Clauses 15-22, further comprising receiving signaling indicating a capability of a transmitting device to support selecting the scheme based on the one or more criteria.

Clause 24: The method of Clause 23, wherein the signaling indicating the capability is received using at least one of: RRC signaling; or a MAC-CE.

Clause 25: The method of any one of Clauses 15-24, wherein the one or more criteria are based on at least one of: a MCS associated with the waveform; a type of the waveform; a capability of the receiving device; or at least one parameter related to performance of the transmitting device.

Clause 26: The method of any one of Clauses 15-25, further comprising transmitting an indication of a scheme for generating a waveform that accounts for unavailable frequency resources, wherein the selection of the scheme is based on the indication.

Clause 27: The method of any one of Clauses 15-26, wherein the generated waveform comprises a single carrier waveform.

Clause 28: The method of any one of Clauses 15-27, further comprising receiving signaling indicating the selected scheme from a transmitting device.

Clause 29: An apparatus, comprising: a memory comprising executable instructions; and a processor configured to execute the executable instructions and cause the apparatus to perform a method in accordance with any one of Clauses 1-28.

Clause 30: An apparatus, comprising means for performing a method in accordance with any one of Clauses 1-28.

Clause 31: A non-transitory computer-readable medium comprising executable instructions that, when executed by a processor of an apparatus, cause the apparatus to perform a method in accordance with any one of Clauses 1-28.

Clause 32: A computer program product embodied on a computer-readable storage medium comprising code for performing a method in accordance with any one of Clauses 1-28.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, a digital signal processor (DSP), an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “a processor,” “at least one processor” or “one or more processors” generally refers to a single processor configured to perform one or multiple operations or multiple processors configured to collectively perform one or more operations. In the case of multiple processors, performance the one or more operations could be divided amongst different processors, though one processor may perform multiple operations, and multiple processors could collectively perform a single operation. Similarly, “a memory,” “at least one memory” or “one or more memories” generally refers to a single memory configured to store data and/or instructions, multiple memories configured to collectively store data and/or instructions.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An apparatus for wireless communication, comprising: a memory comprising computer-executable instructions; and one or more processors configured to execute the computer-executable instructions and cause the apparatus to:
select, based on one or more criteria, a scheme for generating a waveform that accounts for unavailable frequency resources within an allocation of resource elements (REs);
obtain a sequence of frequency domain symbols;
generate the waveform by mapping at least some of the sequence of frequency domain symbols to REs within the allocation according to the selected scheme; and
output the waveform for transmission.

2. The apparatus of claim 1, wherein the scheme for generating the waveform is selected from at least two schemes including at least one of:
a first scheme that shifts at least some of the frequency domain symbols, in order, to avoid mapping to the unavailable frequency resources;
a second scheme that appends at least a first frequency domain symbol of the sequence of frequency domain symbols to at least one end of the allocation of REs in order to avoid mapping to the unavailable frequency resources; or
a third scheme that involves skipping transmission of one or more frequency domain symbols that map to the unavailable frequency resources.

3. The apparatus of claim 1, wherein:
the unavailable frequency resources comprise one or more unavailable REs that form one or more gaps in the allocation of REs; and
the selected scheme avoids the unavailable REs when mapping the sequence of frequency domain symbols to REs.

4. The apparatus of claim 3, wherein the one or more unavailable REs are allocated for comb-based transmissions.

5. The apparatus of claim 3, wherein the one or more criteria are based on at least one of the following parameters:
a number of REs, of the allocation of REs, that are available for outputting the waveform;
a number of the one or more unavailable REs;
a size of at least one of the one or more gaps;
a quantity of the one or more gaps;
a distance of at least one of the one or more gaps from an edge of the allocation;
at least one distance between the one or more gaps; or
at least one threshold value.

6. The apparatus of claim 5, wherein the one or more processors are further configured to execute the computer-executable instructions and cause the apparatus to:
calculate a ratio based on two or more of the parameters, wherein the one or more criteria specify selection of a scheme based on a comparison of the ratio to the at least one threshold value.

7. The apparatus of claim 6, wherein the ratio comprises a ratio of the number of the one or more unavailable REs to a sum of the number of REs of an allocation of REs available for outputting the waveform and the number of the one or more unavailable REs.

8. The apparatus of claim 6, wherein the one or more processors are further configured to execute the computer-executable instructions and cause the apparatus to:
receive signaling indicating the at least one threshold value.

9. The apparatus of claim 1, wherein the one or more processors are further configured to execute the computer-executable instructions and cause the apparatus to:
transmit signaling indicating a capability of the apparatus to support selecting the scheme based on the one or more criteria.

10. The apparatus of claim 9, wherein the signaling indicating a capability is transmitted using at least one of:
radio resource control (RRC) signaling; or
a medium access control (MAC) control element (MAC-CE).

11. The apparatus of claim 1, wherein the one or more criteria are based on at least one of:
a modulation and coding scheme (MCS) associated with the waveform;
a type of the waveform;
a capability of a receiving device; or
at least one parameter related to performance of the apparatus.

12. The apparatus of claim 1, wherein the one or more processors are further configured to execute the computer-executable instructions and cause the apparatus to:
obtain an indication of a scheme for generating a waveform that accounts for unavailable frequency resources, wherein the selection of the scheme is based on the indication.

13. The apparatus of claim 1, wherein the generated waveform comprises a single carrier waveform.

14. The apparatus of claim 1, wherein the one or more processors are further configured to execute the computer-executable instructions and cause the apparatus to:
transmit signaling indicating the selected scheme to a receiving device.

15. An apparatus for wireless communication, comprising: a memory comprising computer-executable instructions; and one or more processors configured to execute the computer-executable instructions and cause the apparatus to:
obtain a waveform;
select, based on one or more criteria, a scheme for processing the waveform that accounts for unavailable frequency resources within an allocation of resource elements (REs); and
extract a sequence of frequency domain symbols from the waveform based on the selected scheme.

16. The apparatus of claim 15, wherein the scheme for generating the waveform is selected from at least two schemes including at least one of:
a first scheme that shifts at least some of the frequency domain symbols, in order, to avoid mapping to the unavailable frequency resources;
a second scheme that appends at least a first frequency domain symbol of the sequence of frequency domain symbols to at least one end of the allocation of REs in order to avoid mapping to the unavailable frequency resources; or
a third scheme that involves skipping transmission of one or more frequency domain symbols that map to the unavailable frequency resources.

17. The apparatus of claim 15, wherein:
the unavailable frequency resources comprise one or more unavailable REs that form one or more gaps in the allocation of REs; and
the selected scheme avoids the unavailable REs when demapping the sequence of frequency domain symbols from REs.

18. The apparatus of claim 17, wherein the one or more unavailable REs are allocated for comb-based transmissions.

19. The apparatus of claim 17, wherein the one or more criteria are based on at least one of the following parameters:
a number of REs, of the allocation of REs, that are available for outputting the waveform;
a number of the one or more unavailable REs;
a size of at least one of the one or more gaps;
a quantity of the one or more gaps;
a distance of at least one of the one or more gaps from an edge of the allocation;
at least one distance between the one or more gaps; or
at least one threshold value.

20. The apparatus of claim 19, wherein the one or more processors are further configured to execute the computer-executable instructions and cause the apparatus to:
calculate a ratio based on two or more of the parameters, wherein the one or more criteria specify selection of a scheme based on a comparison of the ratio to the at least one threshold value.

21. The apparatus of claim 20, wherein the ratio comprises a ratio of the number of the one or more unavailable REs to a sum of the number of REs of an allocation of REs available for outputting the waveform and the number of the one or more unavailable REs.

22. The apparatus of claim 20, wherein the one or more processors are further configured to execute the computer-executable instructions and cause the apparatus to:
transmit signaling indicating the at least one threshold value.

23. The apparatus of claim 15, wherein the one or more processors are further configured to execute the computer-executable instructions and cause the apparatus to:
receive signaling indicating a capability of a transmitting device to support selecting the scheme based on the one or more criteria.

24. The apparatus of claim 23, wherein the signaling indicating the capability is received using at least one of:
radio resource control (RRC) signaling; or
a medium access control (MAC) control element (MAC-CE).

25. The apparatus of claim 15, wherein the one or more criteria are based on at least one of:
a modulation and coding scheme (MCS) associated with the waveform;
a type of the waveform;
a capability of the apparatus; or
at least one parameter related to performance of a transmitting device that transmitted the waveform.

26. The apparatus of claim 15, wherein the one or more processors are further configured to execute the computer-executable instructions and cause the apparatus to:
transmit an indication of a scheme for generating a waveform that accounts for unavailable frequency resources, wherein the selection of the scheme is based on the indication.

27. The apparatus of claim 15, wherein the waveform comprises a single carrier waveform.

28. The apparatus of claim 15, wherein the one or more processors are further configured to execute the computer-executable instructions and cause the apparatus to:
receive signaling indicating the selected scheme from a transmitting device.

29. A method of wireless communication, comprising:
selecting, based on one or more criteria, a scheme for generating a waveform that accounts for unavailable frequency resources within an allocation of resource elements (REs);
obtaining a sequence of frequency domain symbols;
generating the waveform by mapping at least some of the sequence of frequency domain symbols to REs within the allocation according to the selected scheme; and
outputting the waveform for transmission.

30. A method of wireless communication, comprising:
obtaining a waveform;
selecting, based on one or more criteria, a scheme for processing the waveform that accounts for unavailable frequency resources within an allocation of resource elements (REs); and
extracting a sequence of frequency domain symbols from the waveform based on the selected scheme.
